(19) United States
(12) Patent Application Publication
(10) Pub. No.: US 2025/0150562 A1
(43) Pub. Date: May 8, 2025

(54) ELECTRONIC DEVICE AND METHOD FOR CONTROLLING SAME

(71) Applicant: SAMSUNG ELECTRONICS Co., LTD., Suwon-si (KR)

(72) Inventors: Kisung LEE, Suwon-si (KR); Kibum SEONG, Suwon-si (KR); Bonseuk GOO, Suwon-si (KR); Youngtae KIM, Suwon-si (KR); Byungseok SOH, Suwon-si (KR); Youngchol LEE, Suwon-si (KR); Weonhee LEE, Suwon-si (KR); Yongseok JANG, Suwon-si (KR)

(73) Assignee: SAMSUNG ELECTRONICS Co., LTD., Suwon-si (KR)

(21) Appl. No.: 18/999,637

(22) Filed: Dec. 23, 2024

Related U.S. Application Data
(63) Continuation of application No. PCT/KR2023/005670, filed on Apr. 26, 2023.

(30) Foreign Application Priority Data
Jun. 23, 2022 (KR) 10-2022-0077013
Sep. 5, 2022 (KR) 10-2022-0112237

(51) Int. Cl. H04N 9/31

(52) U.S. Cl. CPC H04N 9/3185; H04N 9/317; H04N 9/3194

(57) ABSTRACT

An electronic device configured to project an image on a screen whose curvature is variable, may include: a projector; at least one processor; a communication interface configured to communicate with the screen; and memory storing images and instructions that, when executed by the at least one processor, cause the at least one processor to: obtain a curvature value of the screen based on context information related to the screen; transmit a control signal through the communication interface to the screen for bending the screen based on the curvature value; correct an image of the images stored in the memory based on the curvature value; and control the projector to project the corrected image on the screen.

### CROSS-REFERENCE TO RELATED APPLICATIONS

This application is a bypass continuation of International Application No. PCT/KR2023/005670, filed on Apr. 26, 2023, which is based on and claims priority to Korean Patent Application No. 10-2022-0077013, filed on Jun. 23, 2022, and Korean Patent Application No. 10-2022-0112237, filed on Sep. 5, 2022, in the Korean Intellectual Property Office, the disclosures of which are incorporated by reference herein in their entireties.

### BACKGROUND

### 1. Field

The disclosure relates to an electronic device and a method for controlling the same, and more particularly, to an electronic device that projects an image on a screen device, and a method for controlling the same.

### 2. Description of Related Art

An electronic device (e.g., a projector) may project a projection image designated according to a user command on a projection surface. Here, a projection surface may mean a physical area wherein a projection image is output. A projection surface may be a wall surface or a separate screen of a white tone, etc. in general.

Sometimes, the existing structure used as a projection surface does not deliver ideal performance.

Also, in general, an projector does not account for a position of a user. Accordingly, there may be a problem that a degree of distortion of an image is different depending on in which position the user views the projected image.

### SUMMARY

The disclosure was devised for improving the aforementioned problems, and the purpose of the disclosure is in providing an electronic device that controls a curvature of a screen device based on context information, and projects an image on the screen device, and a method for controlling the same.

According to an aspect of the disclosure, an electronic device configured to project an image on a screen whose curvature is variable, may include: a projector; at least one processor; a communication interface configured to communicate with the screen; and memory storing images and instructions that, when executed by the at least one processor, cause the at least one processor to: obtain a curvature value of the screen based on context information related to the screen; transmit a control signal through the communication interface to the screen for bending the screen based on the curvature value; correct an image of the images stored in the memory based on the curvature value; and control the projector to project the corrected image on the screen.

The electronic device may further include a sensor. The instructions may further cause the at least one processor to: obtain first position information of the screen; obtain second position information of a user based on sensing data obtained through the sensor; and obtain the curvature value based on the first position information and the second position information. The context information may include the first position information and the second position information.

The instructions may further cause the at least one processor to: transmit a request signal through the communication interface to the screen for identifying a position of the screen; and obtain the first position information of the screen based on a response signal received through the communication interface.

The instructions may further cause the at least one processor to: obtain first distance information between the screen and the electronic device based on the first position information; and obtain second distance information between the user and the electronic device based on the second position information. The context information may include the first position information, the second position information, the first distance information, and the second distance information.

The instructions may further cause the at least one processor to: obtain a content type corresponding to the image; and obtain the curvature value based on the content type of the image. The context information may include the content type.

The instructions may further cause the at least one processor to: obtain the first position information of the screen; and correct the image based on the first position information and the curvature value.

The image may include a plurality of pixels. The instructions may further cause the at least one processor to: obtain projection positions wherein the plurality of pixels are projected on the screen; and correct the image based on distances between the electronic device and the projection positions of the plurality of pixels.

The instructions may further cause the at least one processor to: based on receiving a user input through the communication interface from a terminal device, obtained based on a UI displayed on the terminal device, determine a curvature value of the user input as the curvature value. The user input may be a drag input.

The screen may include: a motor; a screen element; a support that supports the screen element; and a guide configured to bend the screen element by contacting the support. The control signal may be for controlling the motor such that the guide contacts the support and the screen element is bent based on the curvature value.

The control signal may be for the guide to contact at least one area from among a first portion of the support or a second portion of the support and bend the screen element based on the curvature value.

According to an aspect of the disclosure, a method for controlling an electronic device configured to project an image on a screen whose curvature is variable, the method may include: obtaining a curvature value of the screen based on context information related to the screen; transmitting a control signal to the screen for bending the screen based on the curvature value; correcting the image based on the curvature value; and projecting the corrected image on the screen.

The method may further include: obtaining first position information of the screen; obtaining second position information of a user based on sensing data obtained through a sensor of the electronic device; and obtaining the curvature value based on the first position information and the second position information. The context information may include the first position information and the second position information.

The obtaining the first position information may include: transmitting a request signal to the screen for identifying a position of the screen; and obtaining the first position information of the screen based on a received response signal.

The obtaining the context information may include: obtaining first distance information between the screen and the electronic device based on the first position information; and obtaining second distance information between the user and the electronic device based on the second position information. The context information may include the first position information, the second position information, the first distance information, and the second distance information.

The obtaining the curvature value may include: obtaining a content type corresponding to the image; and obtaining the curvature value based on the content type of the image. The context information may include the content type.

According to an aspect of the disclosure, an electronic device configured to project an image on a screen whose curvature is variable, may include: a projector; at least one processor; a communication interface configured to communicate with the screen; and memory storing images and instructions that, when executed by the at least one processor, cause the at least one processor to: obtain first position information of the screen; obtain second position information of a first user; obtain third position information of a second user; obtain a curvature value of the screen based on the first position information, the second position information, and the third position information; transmit a control signal through the communication interface to the screen for bending the screen based on the curvature value; correct an image of the images stored in the memory based on the curvature value; and control the projector to project the corrected image on the screen.

### BRIEF DESCRIPTION OF THE DRAWINGS

Above and other aspects, features, and advantages of certain embodiments of the present disclosure will be more apparent from the following description taken in conjunction with the accompanying drawings, in which:

FIG. 1 is a perspective view illustrating an exterior of an electronic device according to one or more embodiments;

FIG. 2 is a block diagram illustrating a configuration of an electronic device according to one or more embodiments;

FIG. 3 is a block diagram illustrating in detail a configuration of the electronic device in FIG. 2 according to one or more embodiments;

FIG. 4 is a perspective view illustrating an exterior of an electronic device according to one or more embodiments;

FIG. 5 is a perspective view illustrating an exterior of an electronic device according to one or more embodiments;

FIG. 6 is a perspective view illustrating an exterior of an electronic device according to one or more embodiments;

FIG. 7 is a perspective view illustrating an exterior of an electronic device according to one or more embodiments;

FIG. 8 is a perspective view illustrating an exterior of an electronic device according to one or more embodiments;

FIG. 9 is a perspective view illustrating an exterior of an electronic device according to one or more embodiments;

FIG. 10 is a diagram for illustrating rotation information of an electronic device according to one or more embodiments;

FIG. 11 is a diagram for illustrating rotation information of a projection surface according to one or more embodiments;

FIG. 12 is a diagram for illustrating an operation of changing a curvature of a screen device according to one or more embodiments;

FIG. 13 is a block diagram illustrating a configuration of a screen device according to one or more embodiments;

FIG. 14 is a flow chart for illustrating an operation of projecting a projection image based on a curvature value of a screen device according to one or more embodiments;

FIG. 15 is a flow chart illustrating in detail the operation in FIG. 14 according to one or more embodiments;

FIG. 16 is a flow chart for illustrating an operation of adjusting a curvature of a screen device and projecting a projection image through an electronic device according to one or more embodiments;

FIG. 17 is a diagram for illustrating position information of a screen device according to one or more embodiments;

FIG. 18 is a diagram for illustrating an operation of projecting a projection image according to adjustment of a curvature of a screen device according to one or more embodiments;

FIG. 19 is a flow chart for illustrating an operation of obtaining a curvature value based on context information including first position information according to one or more embodiments;

FIG. 20 is a diagram for illustrating an operation of identifying position information of a screen device based on sensing data according to one or more embodiments;

FIG. 21 is a flow chart for illustrating an operation of identifying position information of a screen device based on sensing data according to one or more embodiments;

FIG. 22 is a diagram for illustrating an operation of adjusting a curvature of a screen device based on a user position according to one or more embodiments;

FIG. 23 is a flow chart for illustrating an operation of adjusting a curvature of a screen device based on a user position according to one or more embodiments;

FIG. 24 is a diagram for illustrating map data indicating a position of a screen device and a position of a user according to one or more embodiments;

FIG. 25 is a flow chart for illustrating an operation of adjusting a curvature of a screen device based on map data indicating a position of a screen device and a position of a user according to one or more embodiments;

FIG. 26 is a diagram for illustrating an operation of adjusting a curvature of a screen device based on content type information according to one or more embodiments;

FIG. 27 is a flow chart for illustrating an operation of adjusting a curvature of a screen device based on content type information according to one or more embodiments;

FIG. 28 is a diagram for illustrating an operation of correcting an image according to a curvature of a screen device according to one or more embodiments;

FIG. 29 is a diagram for illustrating a curvature radius of a screen device based on a relative position of an electronic device according to one or more embodiments;

FIG. 30 is a diagram for illustrating a curvature radius of a screen device based on a position of a user according to one or more embodiments;

FIG. 31 is a diagram for illustrating an operation of calculating a curvature value and a projection ratio according to one or more embodiments;

FIG. 32 is a diagram for illustrating a horizontal length of a projection area that is changed according to a curvature of a screen device according to one or more embodiments;

FIG. 33 is a flow chart for illustrating an operation of adjusting a curvature of a screen device based on a relation between the screen device and a user according to one or more embodiments;

FIG. 34 is a flow chart for illustrating an operation of obtaining a projection ratio based on size information of a screen device according to one or more embodiments;

FIG. 35 is a diagram for illustrating an operation of correcting a projection image according to one or more embodiments;

FIG. 36 is a diagram for illustrating an operation of correcting a projection image according to one or more embodiments;

FIG. 37 is a diagram for illustrating an operation of correcting a projection image according to one or more embodiments;

FIG. 38 is a flow chart for illustrating an operation of correcting a projection image based on a projection area according to one or more embodiments;

FIG. 39 is a diagram for illustrating an operation of correcting a projection image by dividing a projection area according to one or more embodiments;

FIG. 40 is a flow chart for illustrating an operation of correcting a projection image by dividing a projection area according to one or more embodiments;

FIG. 41 is a diagram for illustrating an operation of adjusting a curvature of a screen device through a terminal device according to one or more embodiments;

FIG. 42 is a diagram for illustrating an operation of adjusting a curvature of a screen device through a terminal device according to one or more embodiments;

FIG. 43 is a diagram for illustrating an operation of adjusting a curvature of a screen device through a terminal device according to one or more embodiments;

FIG. 44 is a flow chart for illustrating an operation of adjusting a curvature of a screen device through a terminal device according to one or more embodiments;

FIG. 45 is a diagram for illustrating an operation of adjusting a curvature of a screen device based on a user gesture according to one or more embodiments;

FIG. 46 is a flow chart for illustrating an operation of adjusting a curvature of a screen device based on a user gesture according to one or more embodiments;

FIG. 47 is a diagram for illustrating an operation of adjusting a curvature of a screen device based on information on the number of users according to one or more embodiments;

FIG. 48 is a flow chart for illustrating an operation of adjusting a curvature of a screen device based on information on the number of users according to one or more embodiments;

FIG. 49 is a diagram for illustrating an operation of projecting a projection image by a plurality of devices according to one or more embodiments;

FIG. 50 is a flow chart for illustrating an operation of projecting a projection image by a plurality of devices according to one or more embodiments;

FIG. 51 is a diagram for illustrating an operation of adjusting a curvature of a screen device according to one or more embodiments; and

FIG. 52 is a flow chart for illustrating a controlling method of an electronic device according to one or more embodiments.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Also, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic device or a device using an electronic device (e.g.: an artificial intelligence electronic device).

Hereinafter, an embodiment of the disclosure will be described in more detail with reference to the accompanying drawings.

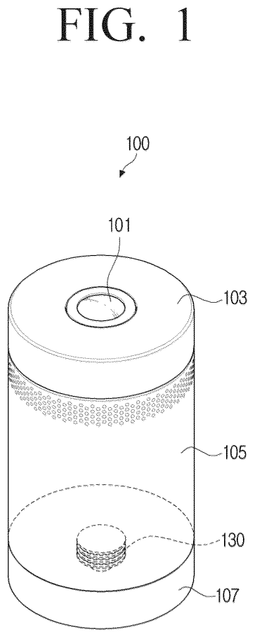

FIG. 1 is a perspective view illustrating an exterior of an electronic device 100 according to one or more embodiments.

Referring to FIG. 1, an electronic device 100 may include a projection lens 101, a head 103, a main body 105, a cover 107, or a connector 130.

The electronic device 100 may be devices in various forms. In particular, the electronic device 100 may be a projector device that enlarges and projects an image to a wall or a screen, and the projector device may be a liquid crystal display (LCD) projector or a digital light processing (DLP) type projector that uses a digital micromirror device (DMD).

In addition, the electronic device 100 may be a home or industrial display device, or an illumination device used in daily life, or an audio device including an audio module. The electronic device 100 may be implemented as a portable communication device (e.g.: a smartphone), a computer device, a portable multimedia device, a wearable device, or a home appliance device, and the like. Meanwhile, the electronic device 100 according to one or more embodiments of the disclosure is not limited to the above-described device, and may be implemented as an electronic device 100 equipped with two or more functions of the above-described devices. For example, the electronic device 100 may be utilized as a display device, an illumination device, or an audio device as its projector function is turned off and its illumination function or a speaker function is turned on according to a manipulation of a processor, or may be utilized as an artificial intelligence (AI) speaker as it includes a microphone or a communication device.

The projection lens 101 may be formed on one surface of the main body 105, and project a light that passed through a lens array to the outside of the main body 105. The projection lens 101 according to the one or more embodiments of the disclosure may be an optical lens that was low-dispersion coated for reducing chromatic aberration. The projection lens 101 may be a convex lens or a condensing lens, and the projection lens 101 according to the one or more embodiments of the disclosure may adjust a focus by adjusting positions of a plurality of sub lenses.

The head 103 may be provided to be coupled to one surface of the main body 105 and support and protect the projection lens 101. The head 103 may be coupled to the main body 105 to be swiveled within a predetermined angle range based on one surface of the main body 105.

The head 103 may be automatically or manually swiveled by the user or the processor and freely adjust a projection angle of the projection lens 101. Alternatively, the head 103 may include a neck that is coupled to the main body 105 and extends from the main body 105, and the head 103 may thus adjust the projection angle of the projection lens 101 by being tilted backward or forward.

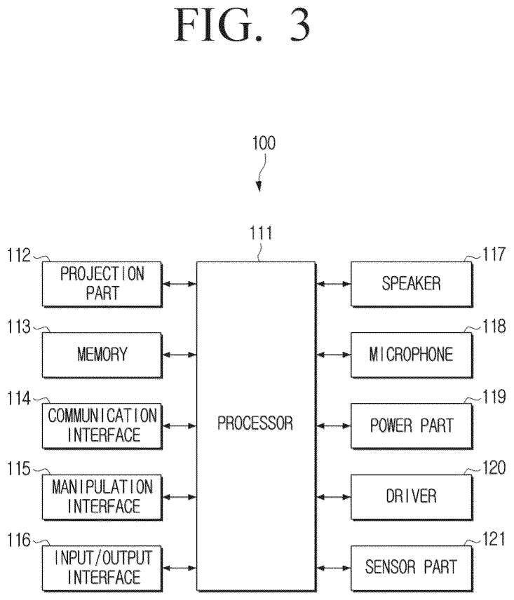

The main body 105 is a housing constituting the exterior, and may support or protect components of the electronic device 100 (e.g., components illustrated in FIG. 3) that are arranged inside the main body 105. The shape of the main body 105 may be a structure close to a cylindrical shape as illustrated in FIG. 1. However, the shape of the main body 105 is not limited thereto, and according to one or more embodiments of the disclosure, the main body 105 may be implemented in various geometrical shapes such as a column having polygonal cross sections, a cone, or a sphere.

The main body 105 may have a size enabling it to be gripped or moved by a user with his/her one hand, or may be implemented in a micro size enabling it to be easily carried by the user or implemented in a size enabling it to be held on a table or coupled to the illumination device.

The material of the main body 105 may be implemented as matt metal or a synthetic resin such that the user's fingerprint or dust is not smeared. Alternatively, the exterior of the main body 105 may consist of a slick glossy material.

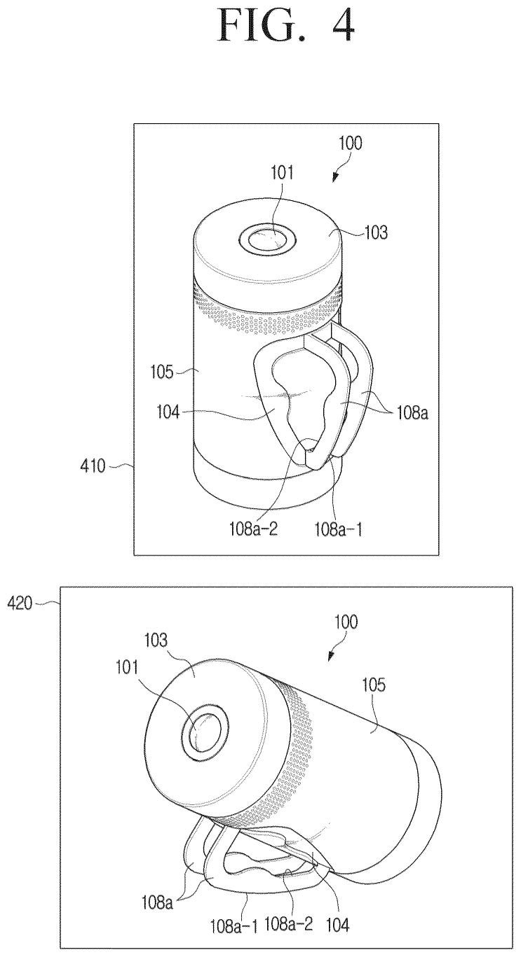

In a partial area of the exterior of the main body 105, a friction area may be formed for the user to grip and move the main body 105. Alternatively, in at least a partial area of the main body 105, a bent gripping part or a support 108a (refer to FIG. 4) that the user can grip may be provided.

The electronic device 100 may project a light or an image to a desired position by adjusting a projection angle of the projection lens 101 while adjusting a direction of the head 103 in a state where the position and angle of the main body 105 are fixed. In addition, the head 103 may include a handle that the user may grip after rotating the head in a desired direction.

A plurality of openings may be formed in an outer circumferential surface of the main body 105. Through the plurality of openings, audio output from an audio outputter may be output to the outside of the main body 105 of the electronic device 100. The audio outputter may include a speaker, and the speaker may be used for general uses such as reproduction of multimedia or reproduction of recording, and output of a voice, etc.

According to the one or more embodiments of the disclosure, the main body 105 may include a radiation fan provided therein, and when the radiation fan is operated, air or heat inside the main body 105 may be discharged through the plurality of openings. Accordingly, the electronic device 100 may discharge heat generated by driving of the electronic device 100 to the outside, and prevent overheating of the electronic device 100.

The connector 130 may connect the electronic device 100 with an external device to transmit or receive electric signals, or receive power from the external device. The connector 130 according to the one or more embodiments of the disclosure may be physically connected with the external device. Here, the connector 130 may include an input/output interface, and connect its communication with the external device in a wired or wireless manner or receive power from the external device. For example, the connector 130 may include a high definition multimedia interface (HDMI) connection terminal, a universal serial bus (USB) connection terminal, a secure digital (SD) card accommodating groove, an audio connection terminal, or a power consent. Alternatively, the connector 130 may include a Bluetooth, wireless-fidelity (Wi-Fi), or a wireless charge connection module, which are connected with the external device in a wireless manner.

In addition, the connector 130 may have a socket structure connected to an external illumination device, and may be connected to a socket accommodating groove of the external illumination device to receive power. The size and specification of the connector 130 having the socket structure may be implemented in various ways in consideration of an accommodating structure of an external device that may be coupled thereto. For example, a diameter of a joining portion of the connector 130 may be implemented as 26 mm according to an international standard E26, and in this case, the electronic device 100 may be coupled to an external illumination device such as a stand in place of a light bulb that is generally used. Meanwhile, when being fastened to a conventional socket positioned on a ceiling, the electronic device 100 may be projected from the upper side to the lower side, and in case the electronic device 100 does not rotate due to socket coupling, the screen cannot be rotated, either. Accordingly, in order that the electronic device 100 can rotate even when it is socket-coupled and receives power, the head 103 of the electronic device 100 may adjust a projection angle by being swiveled on one surface of the main body 105 while the electronic device 100 is socket-coupled to a stand on the ceiling, allowing the electronic device 100 to project a screen or rotate a screen to a desired position.

The connector 130 may include a coupling sensor, and the coupling sensor may detect whether the connector 130 and an external device are coupled, the coupling state, or a coupling target, and transmit the same to the processor, and the processor may control the driving of the electronic device 100 based on the transmitted detection values.

The cover 107 may be coupled to or separated from the main body 105, and protect the connector 130 such that it is not exposed to the outside at all times. The shape of the cover 107 may be a shape continued from the main body 105 as illustrated in FIG. 1, or may be implemented to correspond to the shape of the connector 130. The cover 107 may support the electronic device 100, and the electronic device 100 may be used by being coupled to or held on an external holder while being coupled to the cover 107.

In the electronic device 100 according to the one or more embodiments of the disclosure, a battery may be provided inside the cover 107. The battery may include, for example, a primary cell that cannot be recharged, a secondary cell that may be recharged, or a fuel cell.

The electronic device 100 may include a camera module, and the camera module may capture a still image or a video. According to the one or more embodiments of the disclosure, the camera module may include at least one lens, an image sensor, an image signal processor, or a flash.

Also, the electronic device 100 may include a protection case for the electronic device 100 to be easily carried while being protected. Alternatively, the electronic device 100 may include a stand that supports or fixes the main body 105, and a bracket that can be coupled to a wall surface or a partition.

In addition, the electronic device 100 may be connected with various external devices by using its socket structure, and provide various functions. According to the one or more embodiments of the disclosure, the electronic device 100 may be connected to an external camera device by using the socket structure. The electronic device 100 may provide an image stored in the connected camera device or an image that is currently being captured using a projection part 112 (projector). As another example, the electronic device 100 may be connected to a battery module by using its socket structure to receive power. Meanwhile, the electronic device 100 may be connected to an external device by using its socket structure, but this is merely one of various examples, and the electronic device 100 may be connected an external device by using another interface (e.g., a USB, etc.).

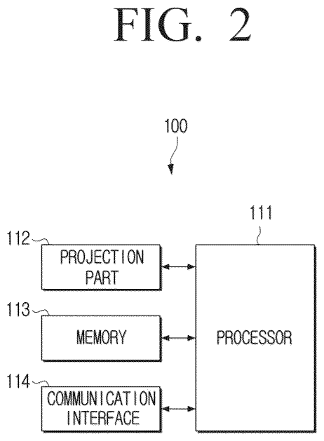

FIG. 2 is a block diagram illustrating a configuration of the electronic device 100 according to one or more embodiments.

Referring to FIG. 2, the electronic device 100 may include at least one processor 111, a projection part 112, memory 113, and a communication interface 114.

Here, the electronic device 100 may be a device that projects images. For example, the electronic device 100 may be a projector.

Here, the screen device 200 (screen) may be a device whose curvature is variable, and may be a device on which images are projected.

The at least one processor 111 may perform overall control operations of the electronic device 100. Specifically, the at least one processor 111 performs a function of controlling the overall operations of the electronic device 100. Detailed explanation related to the at least one processor 111 will be described in FIG. 3.

The projection part 112 is a component that projects an image (a projection image, a content, etc.) to the outside. Detailed explanation related to the projection part 112 will be described in FIG. 3.

The memory 113 may store a projection image. Here, the projection image may mean a real time content received from an external server or an image included in a content that was already stored.

The communication interface 114 may perform communication with the screen device 200. The electronic device 100 may transmit or receive a control signal through the communication interface 114.

The electronic device 100 includes a projection part 112, memory 113 storing an image, a communication interface 114 configured to communicate with the screen device 200, and at least one processor 111 configured to obtain a curvature value of the screen device 200 based on context information including at least one of information related to the screen device 200 or information related to a user, transmit a control signal for bending the screen device 200 based on the curvature value to the screen device 200 through the communication interface 114, correct an image stored in the memory 113 based on the curvature value, and control the projection part 112 to project the corrected image on the screen device 200.

Here, the image may also be described as a projection image in that it is projected by the projection part 112. Hereinafter, an image will be described as a projection image.

Here, the context information may include at least one of state information of the electronic device 100 itself, state information of the screen device 200, environment information or content information of ambient spaces of the electronic device 100 and the screen device 200. Here, the state information of the electronic device 100 may mean information related to the arrangement of the electronic device 100 (e.g., the position, the tilt, etc.). Here, the state information of the screen device 200 may mean information related to the arrangement of the screen device 200 (e.g., the position, the tilt, etc.). Here, the environment information of the ambient spaces may mean information related to the user 20. Meanwhile, the at least one processor 111 may additionally obtain information obtained based on the relation with the screen device 200 or the user 20 as context information.

Specifically, the context information may include at least one of the first position information of the screen device 200, the second position information of the user, map data, content type information, information on a distance between the screen device and the user, information on an angle between the screen device and the user, information on the size of the screen device 200, or information on the number of users.

Meanwhile, the electronic device 100 may output (or project) a content. A content may include at least one of image data or audio data. There may be various methods for receiving a content.

According to one or more embodiments, the electronic device 100 may receive a content through a user's terminal device (e.g., a smartphone, a tablet, etc.).

According to one or more embodiments, the electronic device 100 may receive a content through a server (or an external server).

According to one or more embodiments, the electronic device 100 may receive a content through a universal serial bus (USB) or an interface such as a high definition multimedia interface (HDMI), etc.

According to one or more embodiments, the electronic device 100 may receive a content through an over the top (OTT) device.

A content may include content type information other than image data or audio data. For example, the content type information may include at least one of a movie content, a game content, a still image content, a news content, a documentary content, or an education content.

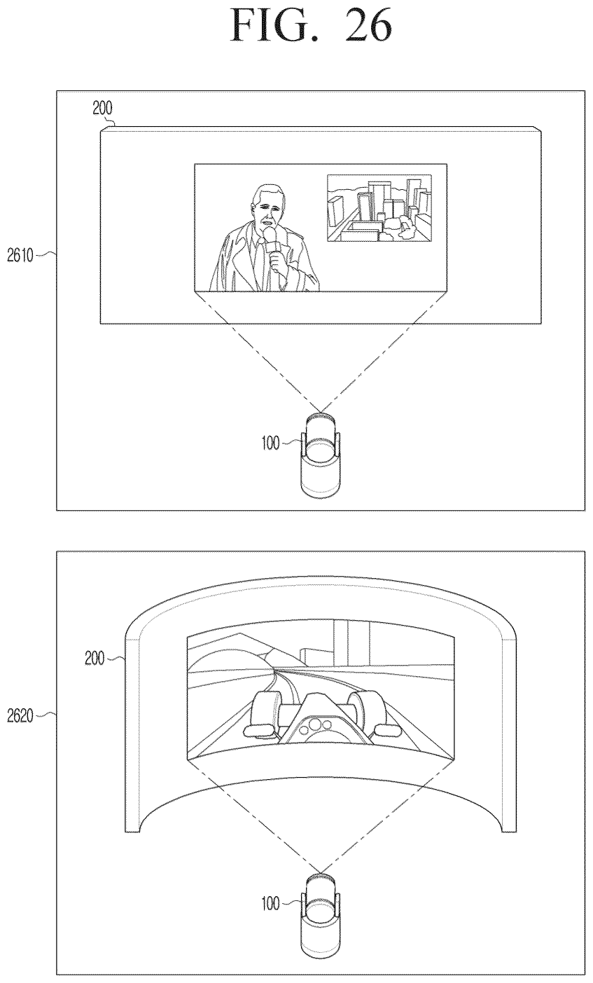

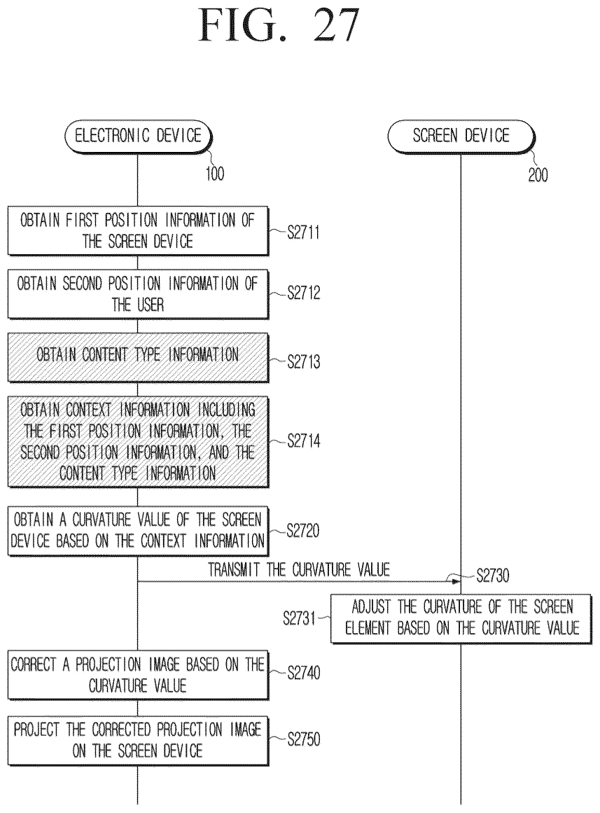

The electronic device 100 may control the curvature of the screen device 200 based on the content type information. An operation of obtaining a curvature value based on context information including content type information will be described in FIG. 26 to FIG. 27.

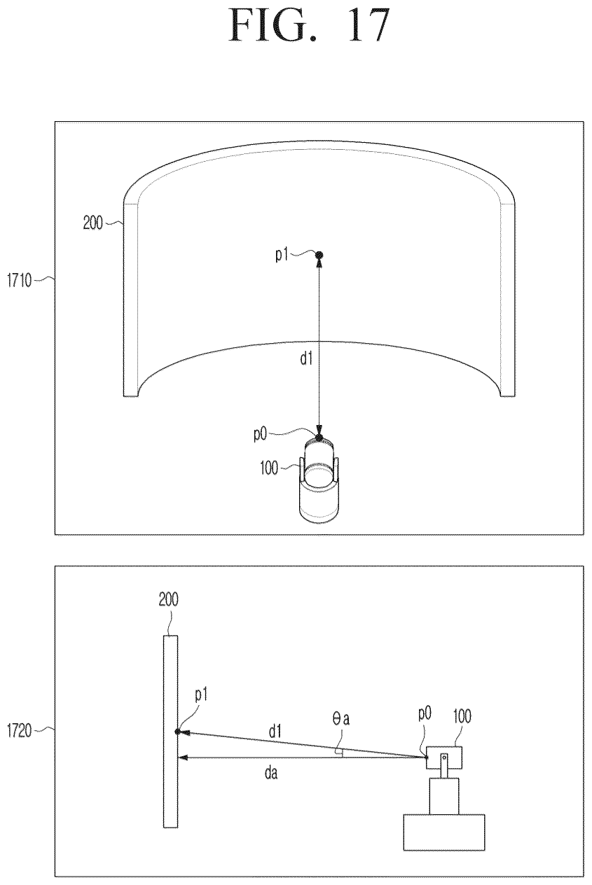

An operation of obtaining a curvature value based on context information including the first position information of the screen device 200 will be described in FIG. 17 to FIG. 19.

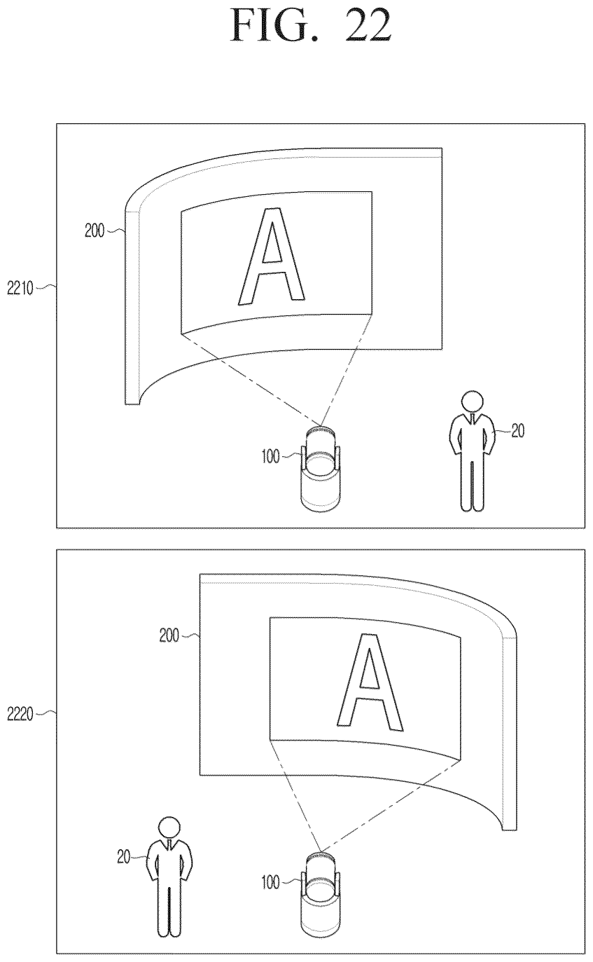

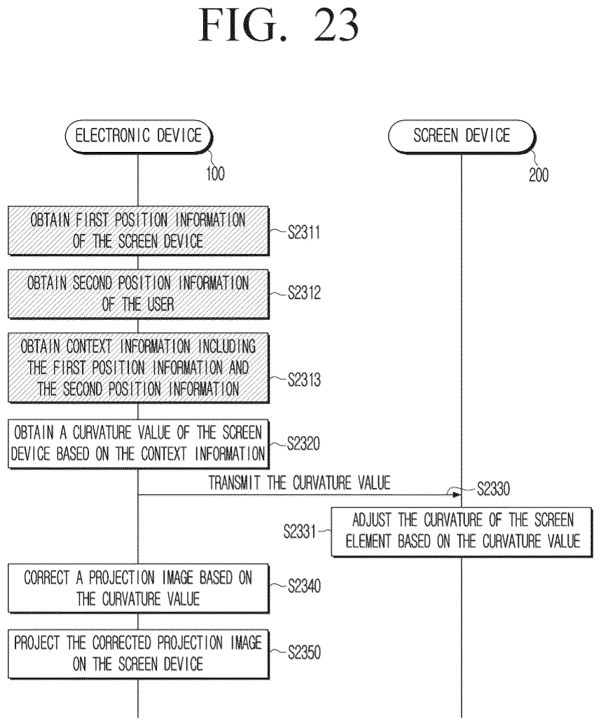

An operation of obtaining a curvature value based on context information including the second position information of the user 20 will be described in FIG. 22 to FIG. 23.

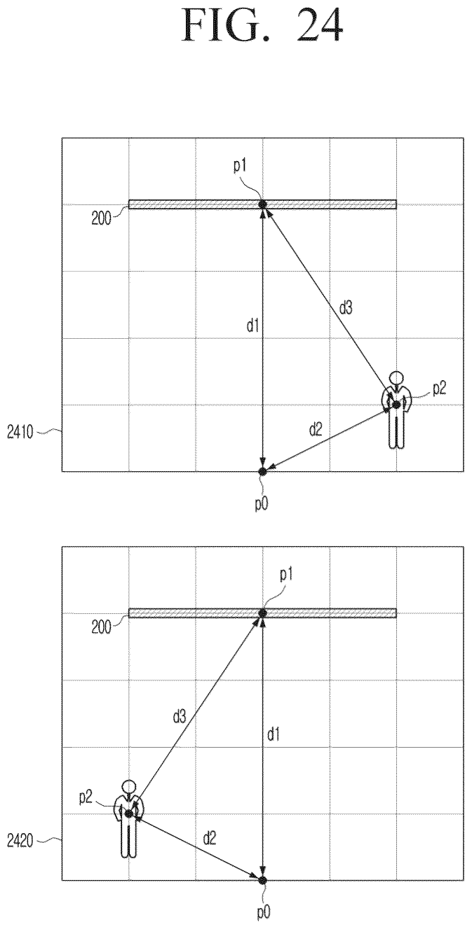

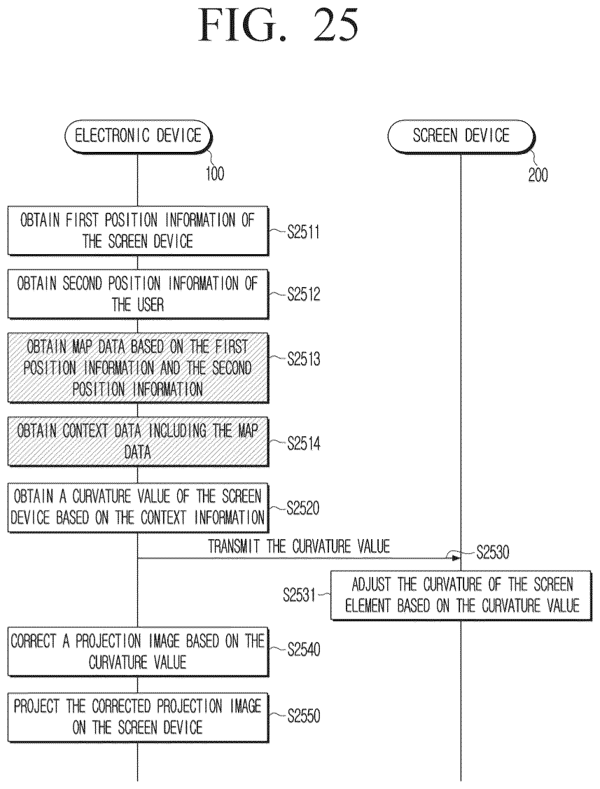

An operation of obtaining a curvature value based on context information including the map data will be described in FIG. 24 to FIG. 25.

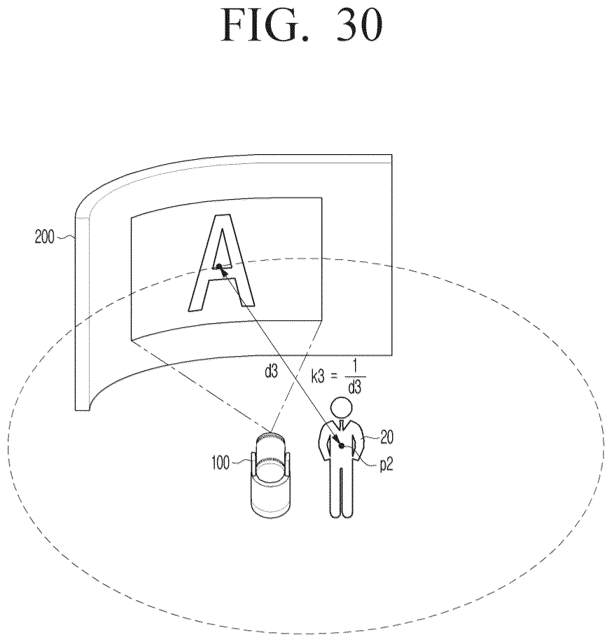

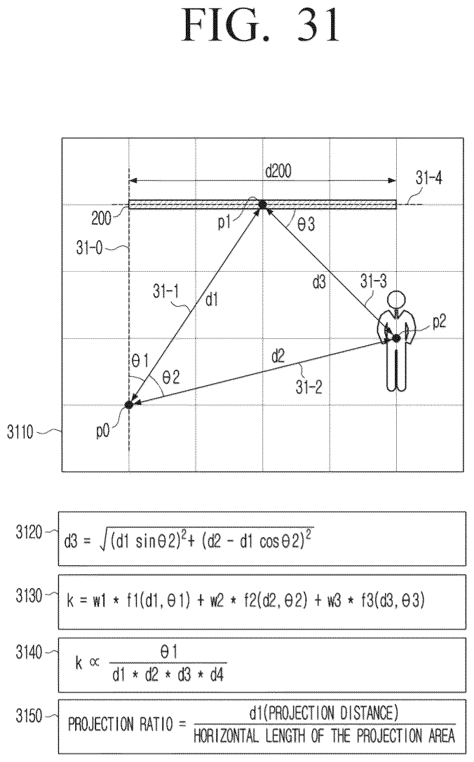

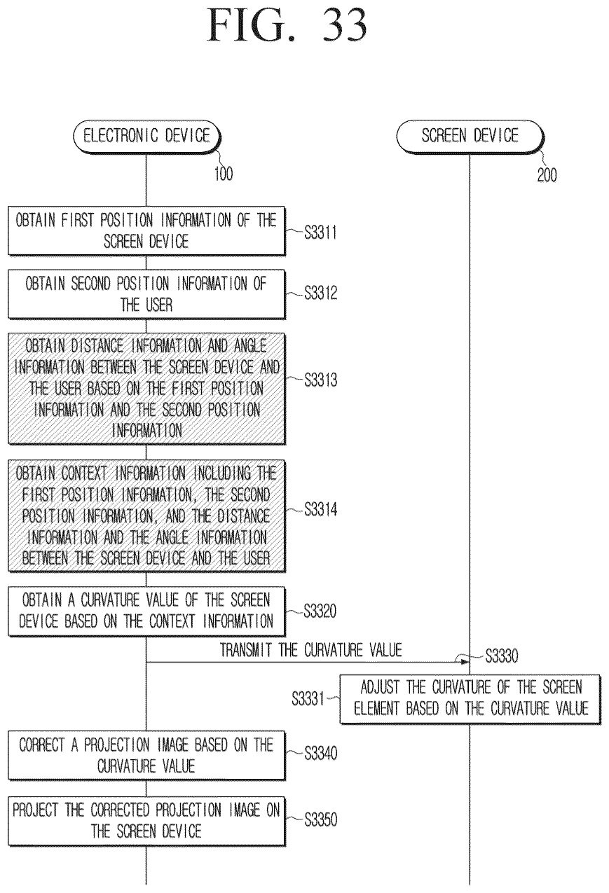

An operation of obtaining a curvature value based on context information including information on a distance between the screen device and the user, and information on an angle between the screen device and the user will be described in FIG. 30, FIG. 31, FIG. 33, etc.

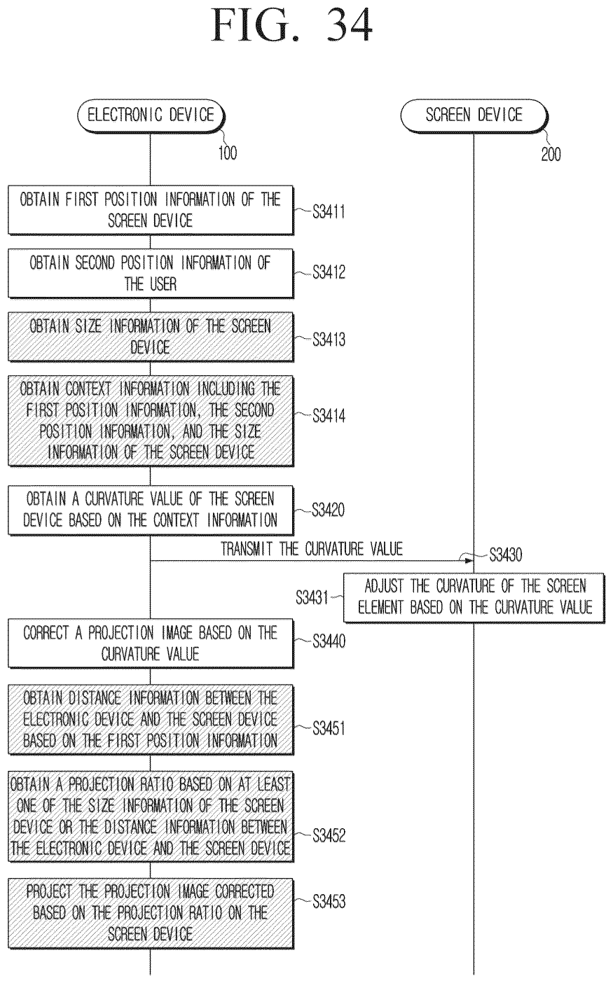

An operation of obtaining a curvature value based on context information including information on the size of the screen device 200 will be described in FIG. 34.

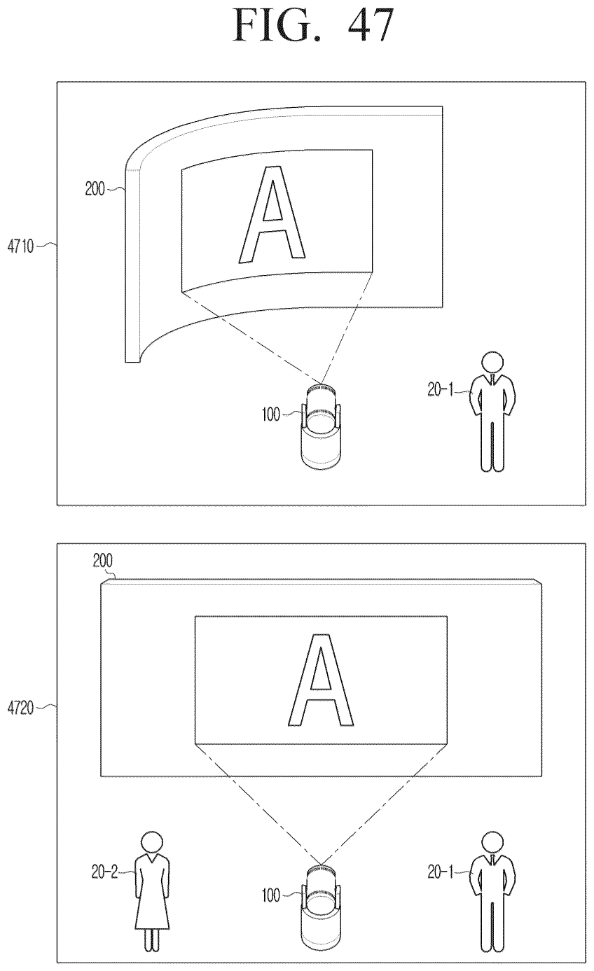

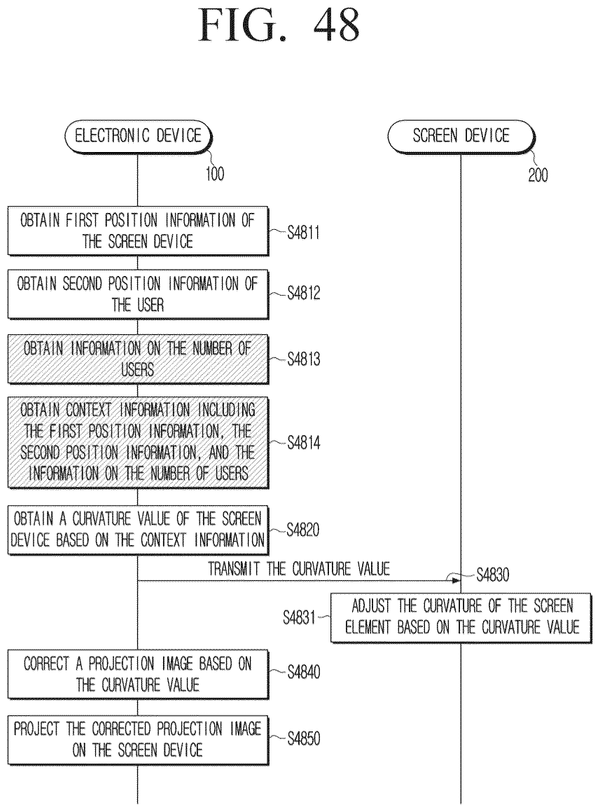

An operation of obtaining a curvature value based on context information including information on the number of users will be described in FIG. 47 to FIG. 48.

The at least one processor 111 may obtain a curvature of the screen device 200 based on context information including various types of information. Then, the at least one processor 111 may generate a control signal (or a control command) for the screen device 200 to be bent based on the obtained curvature value. Then, the at least one processor 111 may transmit the generated control signal (or control command) to the screen device 200 through the communication interface 114.

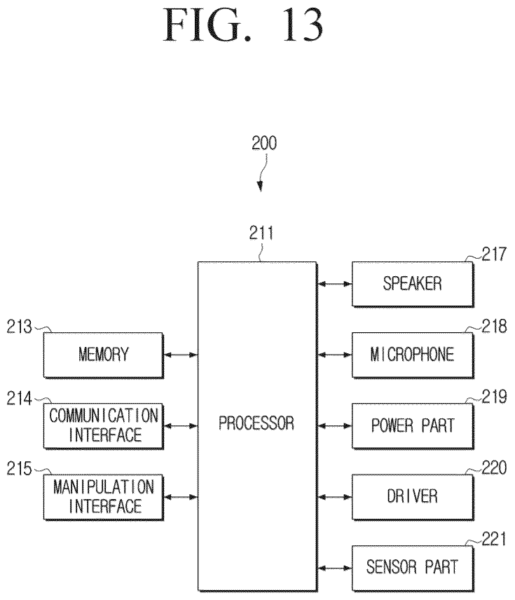

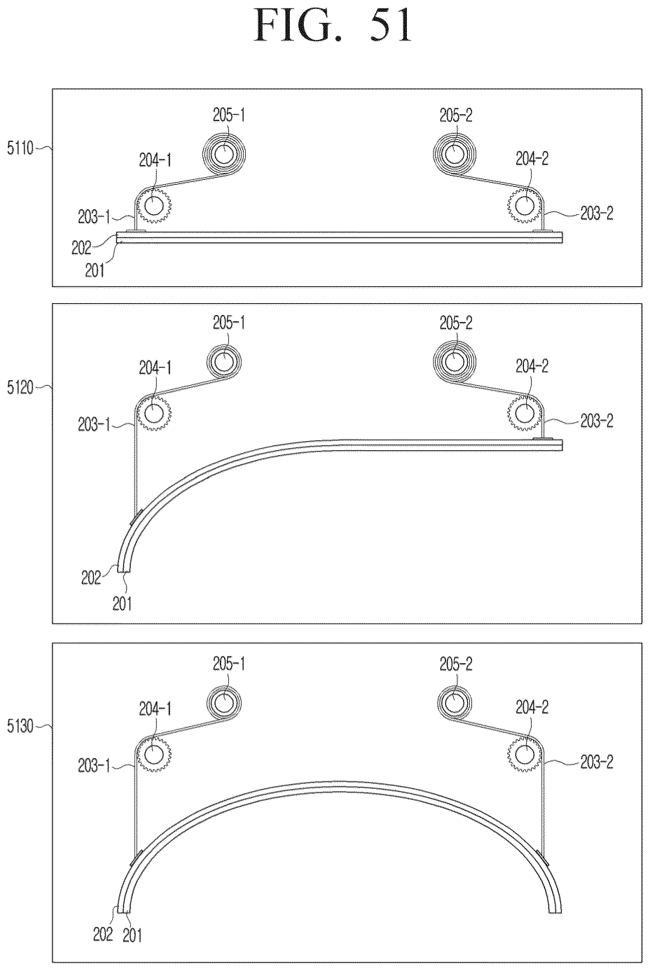

The screen device 200 may control the curvature such that the screen element 201 of the screen device 200 is bent based on the curvature value included in the control signal (or the control command) received from the electronic device 100. The hardware components of the screen device 200 will be described in FIG. 13. The detailed operations of the hardware components for an operation of adjusting the curvature of the screen device 200 will be described in FIG. 51.

Here, the at least one processor 111 may correct a projection image based on the curvature value. This is because, if a projection image is not corrected even though the screen device 200 is bent, the projected image will be seen in a distorted form.

Here, the correcting operation may mean an operation of correcting an image such that a projection image on the bent screen device 200 is not distorted. The image correcting operation may mean keystone correction or leveling correction, etc.

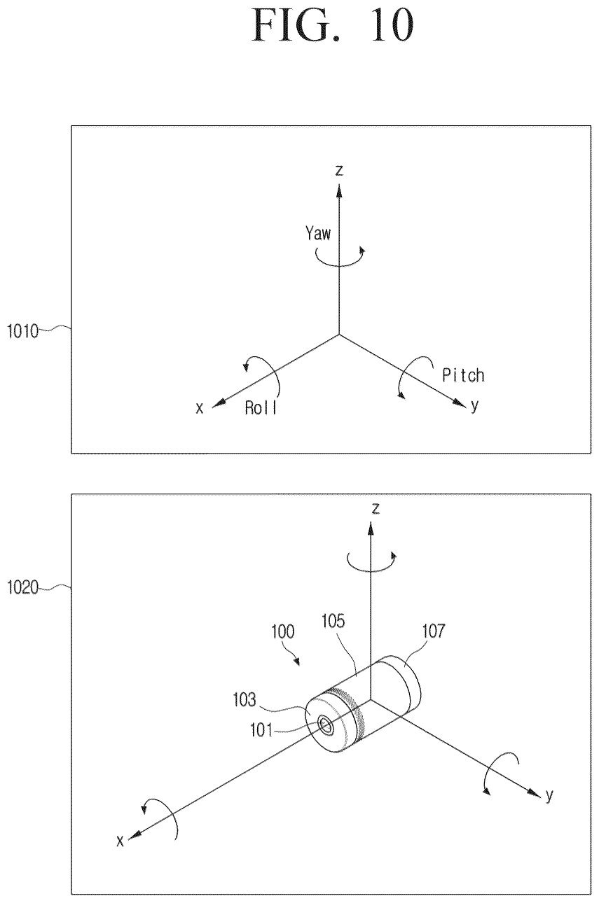

The keystone correction may be an operation of correcting a distorted image according to the state of the electronic device 100 rotated to the z axis or the y axis (refer to FIG. 10). For example, the electronic device 100 may correct an image of a trapezoid form to an image of a rectangular form.

The leveling correction may be an operation of correcting a distorted image according to the state of the electronic device 100 rotated to the x axis (refer to FIG. 10). For example, the electronic device 100 may correct an image that is not parallel to the bottom surface to an image parallel to the bottom surface.

Here, the at least one processor 111 may identify a projection area. The at least one processor 111 may identify a distance between the projection area and the electronic device 100. Then, the at least one processor 111 may correct a projection image based on the identified distance. The projection area may be set on the screen element 201 of the bent screen device 200. Accordingly, the at least one processor 111 may perform an image correcting operation based on the curvature value of the screen device 200.

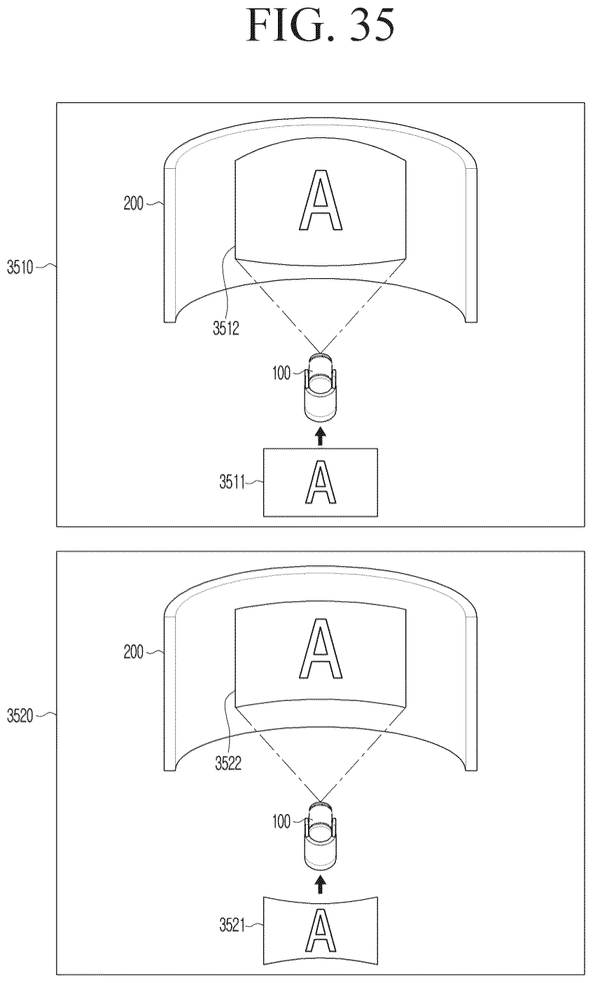

A specific operation related to image correction will be described in FIG. 35 to FIG. 38.

Also, the at least one processor 111 may project the corrected projection image on the screen device 200. Here, the at least one processor 111 may identify a projection direction and a projection angle based on the first position information of the screen device 200. Accordingly, the at least one processor 111 may project the projection image toward the screen device 200.

Meanwhile, the electronic device 100 may further include a sensor part 121. Here, the sensor part 121 may include a distance sensor or an image sensor. The at least one processor 111 may obtain information related to the screen device 200 including the first position information of the screen device 200, obtain information related to the user including the second position information of the user based on sensing data obtained through the sensor part 121, obtain context information including the first position information and the second position information, and obtain a curvature value based on the first position information and the second position information.

Here, the first position information may include information indicating the position of the screen device 200. Here, the second position information may include information indicating the position of the user 20. The at least one processor 111 may include the first position information and the second position information in the context information, and store the information in the memory 113.

There may be one or more embodiments of identifying the position of the screen device 200 and the position of the user 20.

According to one or more embodiments, the at least one processor 111 may identify the screen device 200 or the user 20 by using a distance sensor. Here, the distance sensor may mean a Time of Flight (ToF) sensor for identifying an object (e.g., a human object). The at least one processor 111 may identify whether the screen device 200 exists, the position of the screen device 200, whether the user 20 exists, and the position of the user 20 based on the sensing data obtained through the distance sensor.

According to one or more embodiments, the at least one processor 111 may identify the screen device 200 or the user 20 by using an image sensor. Here, the image sensor may mean a camera that obtains a captured image. The at least one processor 111 may identify whether the screen device 200 exists, the position of the screen device 200, whether the user 20 exists, and the position of the user 20 based on the sensing data (a captured image) obtained through the image sensor.

According to one or more embodiments, the at least one processor 111 may identify the screen device 200 or the user 20 based on a communication signal. An operation of identifying the user 20 based on a communication signal may mean an operation of using a communication signal through a terminal device 300 of the user 20 or a wearable device of the user 20.

Meanwhile, the at least one processor 111 may transmit a request signal for identifying the position of the screen device 200 to the screen device 200 through the communication interface 114, and obtain the first position information of the screen device 200 based on a response signal received through the communication interface 114.

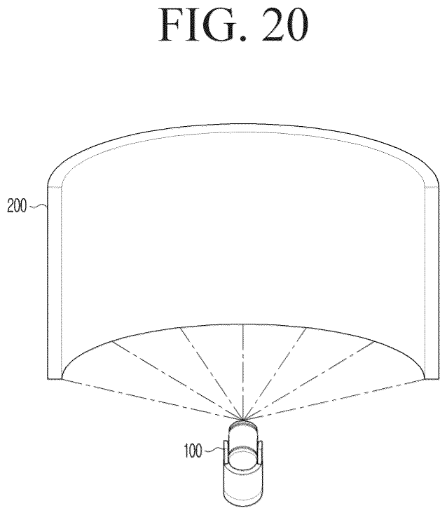

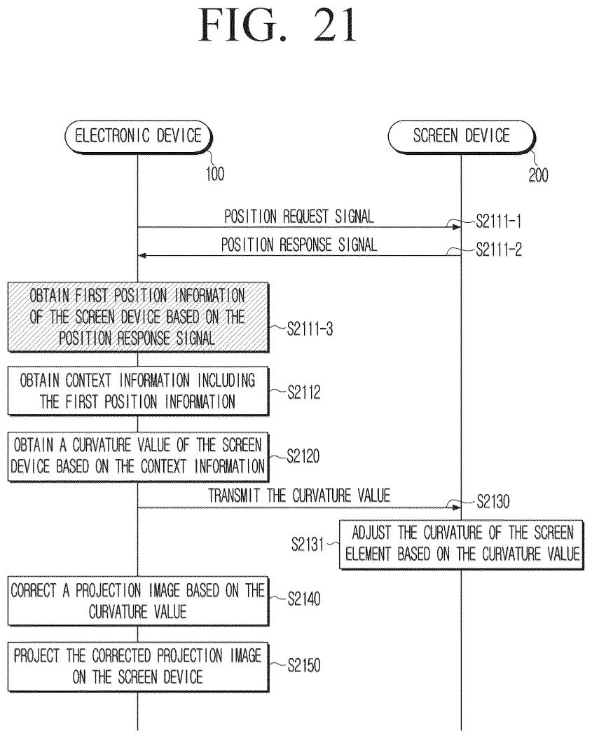

Detailed explanation in this regard will be described in FIG. 20 and FIG. 21.

Meanwhile, the at least one processor 111 may obtain first distance information between the screen device and the electronic device based on the first position information, obtain second distance information between the user and the electronic device based on the second position information, and obtain the context information including the first position information, the second position information, the first distance information, and the second distance information.

Here, the at least one processor 111 may obtain a curvature value based on at least one of the first position information, the second position information, the first distance information, or the second distance information.

Meanwhile, the at least one processor 111 may obtain information on a content type corresponding to a projection image, obtain the context information including the content type information, and obtain the curvature value based on the content type information of the projection image.

Here, the at least one processor 111 may obtain the content type information of the projection image. If the content type information corresponding to the projection image is a predetermined content type, the at least one processor 111 may obtain a curvature value corresponding to the content type information. Here, the predetermined content type may mean a sport content type or a game content type. For example, in case a projection image of a sport content type or a game content type is projected, the at least one processor 111 may determine curvature values corresponding to each content type.

In case a projection image which is not the predetermined content type is projected, the at least one processor 111 may determine the curvature value of the screen device 200 as 0.

A specific operation related to content type information will be described in FIG. 26 and FIG. 27.

Meanwhile, the at least one processor 111 may obtain the first position information of the screen device 200, and correct a projection image based on the first position information and a curvature value.

The at least one processor 111 may correct a projection image based on the position of the screen device 200 and a bent degree (a curvature value) of the screen device 200. The at least one processor 111 may identify a projection area based on the first position information, and correct the projection image based on the bent degree of the identified projection area.

A specific operation related to image correction will be described in FIG. 35 to FIG. 38.

Meanwhile, a projection image may include a plurality of pixels, and the at least one processor 111 may obtain projection positions wherein each of the plurality of pixels is projected on the screen device 200, and correct the projection image based on distances between the electronic device and the projection positions of each of the plurality of pixels.

Here, the projection positions may mean projection areas. The at least one processor 111 may identify in which area an image pixel is projected. Then, the at least one processor 111 may obtain a distance between the electronic device 100 and the position wherein the specific pixel is projected. Then, the at least one processor 111 may correct an image corresponding to the specific pixel based on the obtained distance. Such a correcting operation may be performed for all pixels of the projection image.

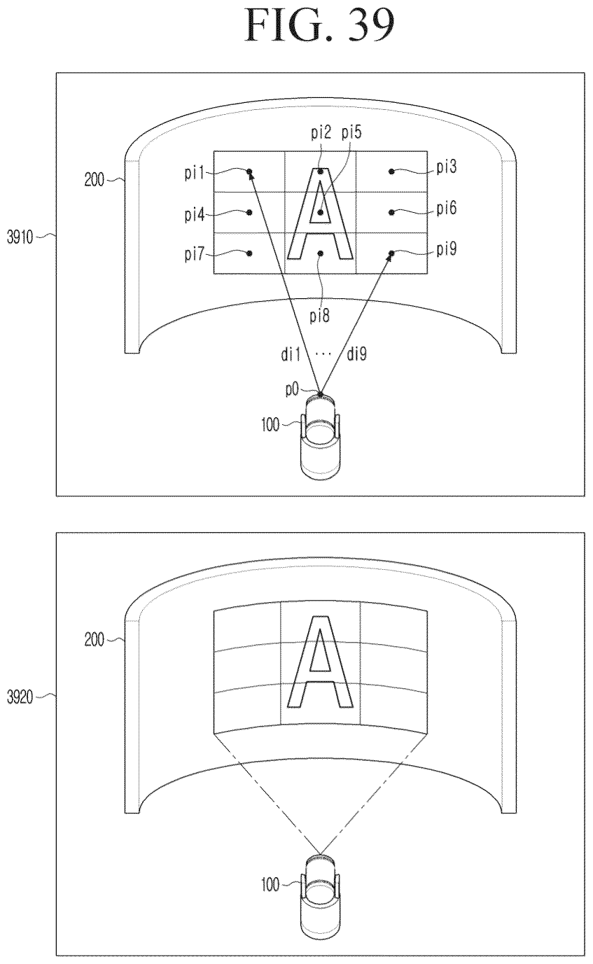

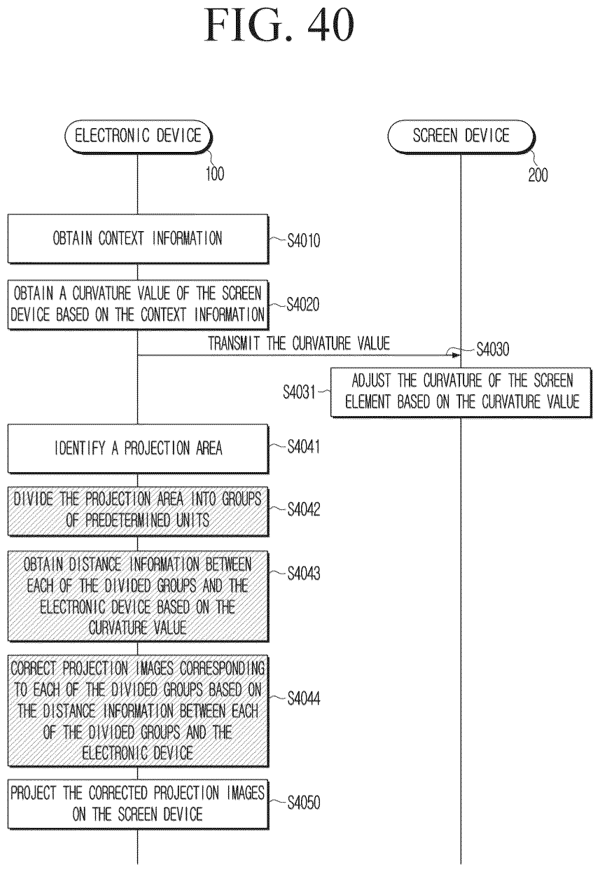

According to one or more embodiments, the at least one processor 111 may perform an image correcting operation based on groups of predetermined units. Detailed explanation in this regard will be described in FIG. 39 and FIG. 40.

Meanwhile, if a user input obtained based on a UI displayed on a terminal device is received from the terminal device through the communication interface 114, the at least one processor 111 may determine a curvature value included in the user input as the curvature value, and the user input may be a drag input.

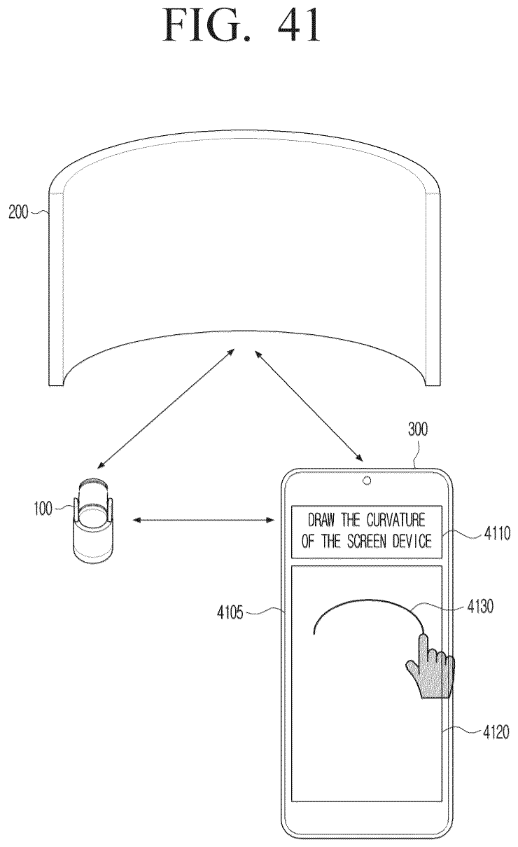

Explanation in this regard will be described in FIG. 41 to FIG. 44.

Meanwhile, the screen device 200 may include a motor 204-1, 204-2, a support element 202 (support) for supporting a screen element 201 of the screen device 200, and a guide element 203-1, 203-2 (guide) for bending the screen element 201 by contacting the support element 202. Also, the at least one processor 111 may transmit a control signal for controlling the motor 204-1, 204-2 such that the guide element 203-1, 203-2 contacts the support element 202 and the screen element 201 is bent based on the curvature value to the screen device 200 through the communication interface 114.

Here, the at least one processor 111 may obtain a curvature value for controlling the curvature of the screen device 200. The at least one processor 111 may transmit a control signal including the curvature value to the screen device 200. The screen device 200 may adjust the curvature of the screen element 201 based on the control signal received from the electronic device 100.

Meanwhile, the at least one processor 111 may transmit a control signal for the guide element 203-1, 203-2 to contact at least one area from among a first portion of the support element 202 or a second portion of the support element 202 and bend the screen element 201 based on the curvature value to the screen device 200 through the communication interface 114.

Detailed explanation related to the screen device 200 will be described in FIG. 51.

Meanwhile, the electronic device 100 according to one or more embodiments may change the curvature of the screen device 200 based on the context information. This does not simply mean that the user directly controls the curvature, but the curvature of the screen device 200 may be automatically adjusted in consideration of the current state of the electronic device 100, the state of the screen device 200, or the ambient environment. Accordingly, the user can automatically experience the curvature of the screen device 200 that is the most appropriate for the current situation.

Also, in case the user directly inputs a user input into the terminal device 300 for directly controlling the curvature of the screen device 200, the user can easily control the curvature of the screen device 200 even if the user is not aware of a separate calculation formula of a curvature or a specialized curve equation.

Meanwhile, in the above, only simple components constituting the electronic device 100 were illustrated and explained, but in actual implementation, various components may additionally be included. Explanation in this regard will be described below with reference to FIG. 3.

FIG. 3 is a block diagram illustrating in detail a configuration of the electronic device 100 in FIG. 2.

Referring to FIG. 3, the electronic device 100 may include at least one of a processor 111, a projection part 112, memory 113, a communication interface 114, a manipulation interface 115, an input/output interface 116, a speaker 117, a microphone 118, a power part 119, a driver 120, or a sensor part 121.

Meanwhile, the components illustrated in FIG. 3 are merely various examples, and some components may be omitted, or new components may be added.

Meanwhile, contents that were already explained in FIG. 2 will be omitted.

The processor 111 may be implemented as a digital signal processor (DSP) processing digital signals, a microprocessor, and a time controller (TCON). However, the disclosure is not limited thereto, and the processor 111 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the processor 111 may be implemented as a system on chip (SoC) having a processing algorithm stored therein or large scale integration (LSI), or implemented in the form of a field programmable gate array (FPGA). In addition, the processor 111 may perform various functions by executing computer executable instructions stored in the memory 113.

The projection part 112 is a component that projects an image to the outside. The projection part 112 according to the one or more embodiments of the disclosure may be implemented in various projection types (e.g., a cathode-ray tube (CRT) type, a liquid crystal display (LCD) type, a digital light processing (DLP) type, a laser type, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into an one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at a fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x and y axes.

Meanwhile, the projection part 112 may include light sources of various types. For example, the projection part 112 may include at least one light source among a lamp, light emitting diodes (LEDs), and a laser.

The projection part 112 may output an image in a screen ratio of 4:3, a screen ratio of 5:4, and a wide screen ratio of 16:9 according to the use of the electronic device 100 or the user's setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

Meanwhile, the projection part 112 may perform various functions for adjusting an output image by control by the processor 111. For example, the projection part 112 may perform functions such as zoom, keystone, quick corner (four corner) keystone, lens shift, etc.

Specifically, the projection part 112 may enlarge or reduce an image according to its distance (i.e., a projection distance) to the screen. That is, a zoom function may be performed according to the distance to the screen. Here, the zoom function may include a hardware method of adjusting a screen size by moving a lens, and a software method of adjusting the screen size by cropping an image, or the like. Meanwhile, when the zoom function is performed, it is necessary to adjust a focus of an image. For example, a method of adjusting a focus includes a manual focusing method, an electric focusing method, etc. The manual focusing method may mean a method of manually adjusting the focus, and the electric focusing method may mean a method in which a projector automatically adjusts the focus by using a built-in motor when the zoom function is performed. When performing the zoom function, the projection part 112 may provide a digital zoom function through software, and may provide an optical zoom function in which the zoom function is performed by moving the lens through the driver 120.

In addition, the projection part 112 may perform a keystone correction function. When a height does not match a front projection, the screen may be distorted up or down. The keystone correction function means a function of correcting a distorted screen. For example, if a distortion of an image occurs in a left-right direction of the screen, the screen may be corrected by using a horizontal keystone, and if a distortion of an image occurs in an up-down direction, the screen may be corrected by using a vertical keystone. The quick corner (four corner) keystone correction function is a function of correcting a screen in case the central area of the screen is normal but the corner areas are out of balance. The lens shift function is a function of moving a screen as it is in case the screen is outside a screen area.

Meanwhile, the projection part 112 may provide the zoom/keystone/focusing functions by automatically analyzing a surrounding environment and a projection environment without a user input. Specifically, the projection part 112 may automatically provide the zoom/keystone/focusing functions based on the distance between the electronic device 100 and the screen, information about a space where the electronic device 100 is currently positioned, information about an amount of ambient light, etc. detected through a sensor (e.g., a depth camera, a distance sensor, an infrared sensor, an illumination sensor, etc.).

Also, the projection part 112 may provide an illumination function by using a light source. In particular, the projection part 112 may provide the illumination function by outputting a light source by using LEDs. According to one or more embodiments, the projection part 112 may include one LED. According to another embodiment, the electronic device 100 may include a plurality of LEDs. Meanwhile, the projection part 112 may output a light source by using a surface emitting LED depending on implementation examples. Here, a surface emitting LED may mean an LED having a structure wherein an optical sheet is arranged on the upper side of the LED such that a light source is evenly dispersed and output. Specifically, if a light source is output through an LED, the light source may be evenly dispersed through an optical sheet, and the light source dispersed through the optical sheet may be incident on a display panel.

Meanwhile, the projection part 112 may provide a dimming function for adjusting the intensity of a light source to the user. Specifically, if a user input for adjusting the intensity of a light source is received from the user through the manipulation interface 115 (e.g., a touch display button or a dial), the projection part 112 may control the LED to output the intensity of the light source that corresponds to the received user input.

In addition, the projection part 112 may provide the dimming function based on a content analyzed by the processor 111 without a user input. In addition, the projection part 112 may control the LED to output the intensity of a light source based on information on a content that is currently provided (e.g., the content type, the content brightness, etc.).

Meanwhile, the projection part 112 may control a color temperature by control by the processor 111. Here, the processor 111 may control a color temperature based on a content. Specifically, if it is identified that a content is to be output, the processor 111 may obtain color information for each frame of the content of which output has been determined. Then, the processor 111 may control the color temperature based on the obtained color information for each frame. Here, the processor 111 may obtain at least one main color of the frame based on the color information for each frame. Then, the processor 111 may adjust the color temperature based on the obtained at least one main color. For example, the color temperature that the processor 111 may adjust may be divided into a warm type or a cold type. Here, it is assumed that a frame to be output (referred to as an output frame hereinafter) includes a scene wherein fire broke out. The processor 111 may identify (or obtain) that the main color is red based on the color information included in the current output frame. Then, the processor 111 may identify the color temperature corresponding to the identified main color (red). Here, the color temperature corresponding to the red color may be the warm type. Meanwhile, the processor 111 may use an artificial intelligence model to obtain the color information or the main color of a frame. According to one or more embodiments, the artificial intelligence model may be stored in the electronic device 100 (e.g., the memory 113). According to another embodiment, the artificial intelligence model may be stored in an external server that can communicate with the electronic device 100.

The memory 113 may be implemented as internal memory such as ROM (e.g., electrically erasable programmable read-only memory (EEPROM)), RAM, etc., included in the processor 111, or implemented as separate memory from the processor 111. In this case, the memory 113 may be implemented in the form of memory embedded in the electronic device 100, or implemented in the form of memory that can be attached to or detached from the electronic device 100 according to the use of stored data. For example, in the case of data for driving the electronic device 100, the data may be stored in memory embedded in the electronic device 100, and in the case of data for an extended function of the electronic device 100, the data may be stored in memory that can be attached to or detached from the electronic device 100.

Meanwhile, in the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

The memory 113 may store at least one instruction related to the electronic device 100. Also, the memory 113 may store an operating system (O/S) for driving the electronic device 100. In addition, the memory 113 may store various types of software programs or applications for the electronic device 100 to operate according to the one or more embodiments of the disclosure. Further, the memory 113 may include semiconductor memory such as flash memory, etc., or a magnetic storage medium such as a hard disk, etc.

Specifically, the memory 113 may store various types of software modules for the electronic device 100 to operate according to the one or more embodiments of the disclosure, and the processor 111 may control the operations of the electronic device 100 by executing the various types of software modules stored in the memory 113. That is, the memory 113 may be accessed by the processor 111, and reading/recording/correction/deletion/update, etc. of data by the processor 111 may be performed.

Meanwhile, in the disclosure, the term “memory 113” may be used as a meaning including a storage, ROM and RAM inside the processor 111, or a memory card (e.g., a micro SD card, a memory stick) mounted on the electronic device.

The communication interface 114 is a component that performs communication with various types of external devices according to various types of communication methods. The communication interface 114 may include a wireless communication module or a wired communication module. Here, each communication module may be implemented in a form of at least one hardware chip.

A wireless communication module may be a module that communicates with an external device wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra wide-band (UWB) module.

The manipulation interface 115 may include various types of input devices. For example, the manipulation interface 115 may include physical buttons. Here, the physical buttons may include function keys, direction keys (e.g., four-direction keys), or dial buttons. According to one or more embodiments, the physical buttons may be implemented as a plurality of keys. According to another embodiment, the physical buttons may be implemented as one key. Here, in case the physical buttons are implemented as one key, the electronic device 100 may receive a user input by which the one key is pressed during a threshold time or longer. If a user input by which the one key is pressed during the threshold time or longer is received, the processor 111 may perform a function corresponding to the user input. For example, the processor 111 may provide the illumination function based on the user input.

Also, the manipulation interface 115 may receive a user input by using a non-contact method. In the case of receiving a user input through a contact method, a physical force should be transmitted to the electronic device 100. Accordingly, a method for controlling the electronic device 100 may be needed regardless of the physical force. Specifically, the manipulation interface 115 may receive a user gesture, and perform an operation corresponding to the received user gesture. Here, the manipulation interface 115 may receive the user gesture through a sensor (e.g., an image sensor or an infrared sensor).

In addition, the manipulation interface 115 may receive A user input by using a touch method. For example, the manipulation interface 115 may receive A user input through a touch sensor. According to one or more embodiments, the touch method may be implemented as the non-contact method. For example, the touch sensor may determine whether a user body approached within a threshold distance. Here, the touch sensor may identify a user input even when the user does not touch the touch sensor. Meanwhile, according to another implementation example, the touch sensor may identify a user input by which the user touches the touch sensor.

Meanwhile, the electronic device 100 may receive a user input in various ways other than the manipulation interface 115 described above. According to one or more embodiments, the electronic device 100 may receive a user input through an external remote control device. Here, the external remote control device may be a remote control device corresponding to the electronic device 100 (e.g., a control device dedicated to the electronic device 100) or a portable communication device (e.g., a smartphone or a wearable device) of the user. Here, the portable communication device of the user may store an application for controlling the electronic device 100. The portable communication device may obtain a user input through the application stored therein, and transmit the obtained user input to the electronic device 100. The electronic device 100 may receive the user input from the portable communication device, and perform an operation corresponding to the user's control command.

Meanwhile, the electronic device 100 may receive a user input by using voice recognition. According to one or more embodiments, the electronic device 100 may receive a user voice through the microphone included in the electronic device 100. According to another embodiment, the electronic device 100 may receive a user voice from the microphone or an external device. Specifically, the external device may obtain a user voice through the microphone of the external device, and transmit the obtained user voice to the electronic device 100. The user voice transmitted from the external device may be audio data or digital data converted from audio data (e.g., audio data converted into a frequency domain, etc.). Here, the electronic device 100 may perform an operation corresponding to the received user voice. Specifically, the electronic device 100 may receive audio data corresponding to the user voice through the microphone. The electronic device 100 may then convert the received audio data into digital data. The electronic device 100 may then convert the converted digital data into text data by using a speech-to-text (STT) function. According to one or more embodiments, the speech-to-text (STT) function may be directly performed in the electronic device 100.

According to another embodiment, the speech-to-text (STT) function may be performed in an external server. The electronic device 100 may transmit digital data to the external server. The external server may convert the digital data into text data, and obtain control command data based on the converted text data. The external server may transmit the control command data (which may here also include the text data) to the electronic device 100. The electronic device 100 may perform an operation corresponding to the user voice based on the obtained control command data.

Meanwhile, the electronic device 100 may provide a voice recognition function by using one assistance (or an artificial intelligence agent such as Bixby™, etc.), but this is merely one of various examples, and the electronic device 100 may provide the voice recognition function through a plurality of assistances. Here, the electronic device 100 may provide the voice recognition function by selecting one of the plurality of assistances based on a trigger word corresponding to the assistance or a specific key included in a remote controller.

Meanwhile, the electronic device 100 may receive a user input by using a screen interaction. A screen interaction may mean a function in which the electronic device 100 identifies whether a predetermined event is generated through an image projected on a screen (or a projection surface), and obtains a user input based on the predetermined event. Here, the predetermined event may be an event in which a predetermined object is identified in a specific position (e.g., a position on which a UI for receiving a user input is projected). Here, the predetermined object may include at least one of the user's body part (e.g., a finger), a pointer, or a laser point. If the predetermined object is identified in the position corresponding to the projected UI, the electronic device 100 may identify that a user input for selecting the projected UI was received. For example, the electronic device 100 may project a guide image such that a UI is displayed on the screen. The electronic device 100 may then identify whether the user selects the projected UI. Specifically, if the predetermined event is identified in the position of the projected UI, the electronic device 100 may identify that the user selected the projected UI. Here, the projected UI may include at least one item. Here, the electronic device 100 may perform spatial analysis to identify whether the predetermined event exists in the position of the projected UI. Here, the electronic device 100 may perform the spatial analysis through the sensor (e.g., an image sensor, an infrared sensor, a depth camera, a distance sensor, etc.). The electronic device 100 may identify whether the predetermined event is generated in the specific position (the position on which the UI is projected) by performing the spatial analysis. Then, if it is identified that the predetermined event is generated in the specific position (the position on which the UI is projected), the electronic device 100 may identify that a user input for selecting the UI corresponding to the specific position was received.

The input/output interface 116 is a component for inputting or outputting at least one of an audio signal or an image signal. The input/output interface 116 may receive at least one of an audio signal or an image signal from an external device, and output a control command to the external device.

Depending on implementation examples, the input/output interface 116 may be implemented as an interface inputting or outputting only audio signals and an interface inputting or outputting only image signals, or implemented as one interface inputting or outputting both audio signals and image signals.

Meanwhile, the input/output interface 116 according to one or more embodiments of the disclosure may be implemented as a wired input/output interface of at least one of a high definition multimedia interface (HDMI), a mobile high-definition link (MHL), a universal serial bus (USB), a USB C-type, a display port (DP), a Thunderbolt, a video graphics array (VGA) port, a red-green-blue (RGB) port, a D-subminiature (D-SUB) or a digital visual interface (DVI). According to one or more embodiments, the wired input/output interface may be implemented as an interface inputting or outputting only audio signals and an interface inputting or outputting only image signals, or implemented as one interface inputting or outputting both audio signals and image signals.

In addition, the electronic device 100 may receive data through the wired input/output interface, but this is merely one of various examples, and the electronic device 100 may receive power through the wired input/output interface. For example, the electronic device 100 may receive power from an external battery through a USB C-type, or receive power from an outlet through a power adapter. As another example, the electronic device 100 may receive power from an external device (e.g., a laptop computer or a monitor, etc.) through a display port (DP).

Meanwhile, the electronic device 100 may be implemented such that an audio signal is input through the wired input/output interface, and an image signal is input through a wireless input/output interface (or the communication interface). Alternatively, the electronic device 100 may be implemented such that an audio signal is input through a wireless input/output interface (or the communication interface), and an image signal is input through the wired input/output interface.

The speaker 117 is a component that outputs audio signals. In particular, the speaker 117 may include an audio output mixer, an audio signal processor, and an audio output module. The audio output mixer may mix a plurality of audio signals to be output as at least one audio signal. For example, the audio output mixer may mix an analog audio signal and another analog audio signal (e.g., an analog audio signal received from the outside) as at least one analog audio signal. The audio output module may include a speaker or an output terminal. According to one or more embodiments, the audio output module may include a plurality of speakers, and in this case, the audio output module may be disposed inside the main body, and audio emitted while covering at least a portion of a diaphragm of the audio output module may pass through a waveguide to be transmitted to the outside of the main body. The audio output module may include a plurality of audio output units, and the plurality of audio output units may be symmetrically disposed on the exterior of the main body, and accordingly, audio may be emitted to all directions, i.e., all directions in 360 degrees.

The microphone 118 is a component for receiving input of a user voice or other sounds, and converting them into audio data. The microphone 118 may receive a voice of a user in an activated state. For example, the microphone 118 may be formed as an integrated type on the upper side or the front surface direction, the side surface direction, etc. of the electronic device 100. The microphone 118 may include various components such as a microphone collecting a user voice in an analogue form, an amp circuit amplifying the collected user voice, an A/D conversion circuit that samples the amplified user voice and converts the user voice into a digital signal, a filter circuit that removes noise components from the converted digital signal, etc.

The power part 119 may receive power from the outside and supply power to the various components of the electronic device 100. The power part 119 according to the one or more embodiments of the disclosure may receive power in various ways. According to one or more embodiments, the power part 119 may receive power by using the connector 130 as illustrated in FIG. 1. In addition, the power part 119 may receive power by using a direct current (DC) power cord of 220V. However, the disclosure is not limited thereto, and the electronic device 100 may receive power by using a USB power cord, or may receive power by using a wireless charging method.

In addition, the power part 119 may receive power by using an internal battery or an external battery. The power part 119 according to the one or more embodiments of the disclosure may receive power through the internal battery. For example, the power part 119 may charge power of the internal battery by using at least one of a DC power cord of 220V, a USB power cord, or a USB C-Type power cord, and may receive power through the charged internal battery. Also, the power part 119 according to the one or more embodiments of the disclosure may receive power through the external battery. For example, the power part 119 may receive power through the external battery in case connection between the electronic device 100 and the external battery is performed through various wired communication methods such as the USB power code, the USB C-type power code, or a socket groove, etc. That is, the power part 119 may directly receive power from the external battery, or charge the internal battery through the external battery and receive power from the charged internal battery.

The power part 119 according to the disclosure may receive power by using at least one of the aforementioned plurality of power supply methods.

Meanwhile, with respect to power consumption, the electronic device 100 may have power consumption of a predetermined value (e.g., 43 W) or less due to the socket type, other standards, etc. Here, the electronic device 100 may vary power consumption to reduce the power consumption when using the battery. That is, the electronic device 100 may vary power consumption based on the power supply method, the power usage amount, or the like.

The driver 120 may drive at least one hardware component included in the electronic device 100. The driver 120 may generate physical force, and transmit the force to at least one hardware component included in the electronic device 100.

Here, the driver 120 may generate driving power for a moving operation of a hardware component included in the electronic device 100 (e.g., moving of the electronic device 100) or a rotating operation of a component (e.g., rotation of the projection lens).

The driver 120 may adjust a projection direction (or a projection angle) of the projection part 122. Also, the driver 120 may move the position of the electronic device 100. Here, the driver 120 may control the moving element 109 for moving the electronic device 100. For example, the driver 120 may control the moving element 109 by using the motor.

The sensor part 121 may include at least one sensor. Specifically, the sensor part 121 may include at least one of a tilt senor that senses the tilt of the electronic device 100 or an image sensor that captures an image. Here, the tilt sensor may be an acceleration sensor or a gyro sensor, and the image sensor may mean a camera or a depth camera. Meanwhile, the tilt sensor may also be described as a motion sensor. Also, the sensor part 121 may include various sensors other than a tilt sensor or an image sensor. For example, the sensor part 121 may include an illumination sensor or a distance sensor. The distance sensor may be a Time of Flight (ToF) sensor. Also, the sensor part 121 may include a LiDAR sensor.

Meanwhile, the electronic device 100 may control the illumination function by being interlocked with an external device. Specifically, the electronic device 100 may receive illumination information from an external device. Here, the illumination information may include at least one of brightness information or color temperature information set in the external device. Here, the external device may mean a device connected to the same network as the electronic device 100 (e.g., an IoT device included in the same home/company network) or a device that is not connected to the same network as the electronic device 100 but can communicate with the electronic device 100 (e.g., a remote control server). For example, it is assumed that an external illumination device (an IoT device) included in the same network as the electronic device 100 is outputting a red lighting at the brightness of 50. The external illumination device (an IoT device) may directly or indirectly transmit illumination information (e.g., information that the red lighting is being output at the brightness of 50) to the electronic device 100. Here, the electronic device 100 may control an output of a light source based on the illumination information received from the external illumination device. For example, if the illumination information received from the external illumination device includes information that the red lighting is being output at the brightness of 50, the electronic device 100 may output the red lighting at the brightness of 50.

Meanwhile, the electronic device 100 may control the illumination function based on biometric information. Specifically, the processor 111 may obtain the biometric information of the user. Here, the biometric information may include at least one of the body temperature, the heart rate, the blood pressure, the breathing, or the electrocardiogram of the user. Here, the biometric information may include various kinds of information other than the aforementioned information. As an example, the electronic device 100 may include a sensor for measuring biometric information. The processor 111 may obtain the biometric information of the user through the sensor, and control an output of a light source based on the obtained biometric information. As another example, the processor 111 may receive biometric information from an external device through the input/output interface 116. Here, the external device may mean a portable communication device (e.g., a smartphone or a wearable device) of the user. The processor 111 may obtain the biometric information of the user from the external device, and control an output of a light source based on the obtained biometric information. Meanwhile, depending on implementation examples, the electronic device 100 may identify whether the user is sleeping, and if it is identified that the user is sleeping (or is preparing to sleep), the processor 111 may control an output of a light source based on the biometric information of the user.

Meanwhile, the electronic device 100 according to the one or more embodiments of the disclosure may provide various smart functions.

Specifically, the electronic device 100 may be connected to a portable terminal device for controlling the electronic device 100, and the screen output from the electronic device 100 may be controlled through a user input that is input into the portable terminal device. For example, the portable terminal device may be implemented as a smartphone including a touch display, and the electronic device 100 may receive screen data provided by the portable terminal device from the portable terminal device and output the data, and the screen output from the electronic device 100 may be controlled according to a user input that is input into the portable terminal device.

The electronic device 100 may perform connection to the portable terminal device through various communication methods such as Miracast, Airplay, wireless Dalvik Executable (DEX) and a remote personal computer (PC) method, etc., and may share a content or music provided by the portable terminal device.

In addition, connection between the portable terminal device and the electronic device 100 may be performed by various connection methods. According to one or more embodiments, the portable terminal device may search for the electronic device 100 and perform wireless connection therebetween, or the electronic device 100 may search for the portable terminal device and perform wireless connection therebetween. The electronic device 100 may then output a content provided by the portable terminal device.

According to one or more embodiments, while a specific content or music is being output from the portable terminal device, if the portable terminal device is positioned around the electronic device 100 and then a predetermined gesture (e.g., a motion tap view) is detected through the display of the portable terminal device, the electronic device 100 may output the content or music that is being output from the portable terminal device.

According to one or more embodiments, while a specific content or music is being output from the portable terminal device, if the portable terminal device becomes close to the electronic device 100 by a predetermined distance or less (e.g., a non-contact tap view), or the portable terminal device touches the electronic device 100 twice at short intervals (e.g., a contact tap view), the electronic device 100 may output the content or music that is being output from the portable terminal device.

In the aforementioned embodiment, it was described that a screen identical to the screen that is being provided on the portable terminal device is provided on the electronic device 100, but the disclosure is not limited thereto. That is, if connection between the portable terminal device and the electronic device 100 is established, a first screen provided by the portable terminal device may be output on the portable terminal device, and a second screen provided by the portable terminal device, which is different from the first screen, may be output on the electronic device 100. As an example, the first screen may be a screen provided by a first application installed in the portable terminal device, and the second screen may be a screen provided by a second application installed in the portable terminal device. For example, the first screen and the second screen may be screens different from each other that are provided by one application installed in the portable terminal device. In addition, for example, the first screen may be a screen including a UI in a remote controller form for controlling the second screen.

The electronic device 100 according to the disclosure may output a standby screen. For example, the electronic device 100 may output a standby screen in case connection between the electronic device 100 and an external device was not performed or there was no input received from an external device during a predetermined time. A condition for the electronic device 100 to output a standby screen is not limited to the above-described example, and a standby screen may be output by various conditions.

The electronic device 100 may output a standby screen in the form of a blue screen, but the disclosure is not limited thereto. For example, the electronic device 100 may obtain an atypical object by extracting only the shape of a specific object from data received from an external device, and output a standby screen including the obtained atypical object.

Meanwhile, the electronic device 100 may further include a display.

The display may be implemented as displays in various forms such as a liquid crystal display (LCD), an organic light emitting diodes (OLED) display, a plasma display panel (PDP), etc. Inside the display, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display may be implemented as a touch screen combined with a touch sensor, a flexible display, a three-dimensional (3D) display, etc. Also, the display according to the one or more embodiments of the disclosure may include not only a display panel outputting images, but also a bezel housing the display panel. In particular, a bezel according to the one or more embodiments of the disclosure may include a touch sensor for detecting user interactions.

Meanwhile, the electronic device 100 may further include a shutter part.

The shutter part may include at least one of a shutter, a fixing element, a rail, or a body.

Here, the shutter may block light output from the projection part 112. Here, the fixing element may fix the location of the shutter. Here, the rail may be a route through which the shutter and the fixing element are moved. Here, the body may be a component including the shutter and the fixing element.

FIG. 4 is a perspective view illustrating an exterior of the electronic device 100 according to one or more embodiments.

Referring to the embodiment 410 in FIG. 4, the electronic device 100 may include a support (or it is referred to as “a handle”) 108a.

The support 108a according to one or more embodiments may be a handle or a ring that is provided for the user to grip or move the electronic device 100. Alternatively, the support 108a may be a stand that supports the main body 105 while the main body 105 is laid sideways.

The support 108a may be connected in a hinge structure so as to be coupled to or separated from the outer circumferential surface of the main body 105, and may be selectively separated from or fixed to the outer circumferential surface of the main body 105 depending on the user's need. The number, shape, or disposition structure of the support 108a may be implemented in various ways without restriction. The support 108a may be built inside the main body 105, and taken out and used by the user depending on the user's need. Alternatively, the support 108a may be implemented as a separate accessory, and attached to or detached from the electronic device 100.

The support 108a may include a first support surface 108a-1 and a second support surface 108a-2. The first support surface 108a-1 may be a surface that faces the outward direction of the main body 105 while the support 108a is separated from the outer circumferential surface of the main body 105, and the second support surface 108a-2 may be a surface that faces the inward direction of the main body 105 while the support 108a is separated from the outer circumferential surface of the main body 105.

The first support surface 108a-1 may be developed from the lower portion to the upper portion of the main body 105 to be farther away from the main body 105, and the first support surface 108a-1 may have a flat or uniformly curved shape. The first support surface 108a-1 may support the main body 105 in case the electronic device 100 is held in such a manner that the outer side surface of the main body 105 is in contact with the bottom surface, i.e., in case the electronic device 100 is disposed in such a manner that the projection lens 101 is toward the front direction. In an embodiment in which the electronic device 100 includes two or more supports 108a, the head 103 and the projection angle of the projection lens 101 may be adjusted by adjusting the interval or hinge opening angle of the two supports 108a.

The second support surface 108a-2 may be a surface touched by the user or an external holding structure when the support 108a is supported by the user or an external holding structure, and may have a shape corresponding to a gripping structure of the user's hand or the external holding structure such that the electronic device 100 does not slip in case the electronic device 100 is supported or moved. The user may move the electronic device 100 by making the projection lens 101 face toward the front direction, and fixing the head 103 and holding the support 108a, and use the electronic device 100 like a flashlight.

The support groove 104 is a groove structure which is provided in the main body 105 and accommodates the support 108a when the support 108a is not used, and it may be implemented as a groove structure corresponding to the shape of the support 108a on the outer circumferential surface of the main body 105. Through the support groove 104, the support 108a may be stored on the outer circumferential surface of the main body 105 when the support 108a is not used, and the outer circumferential surface of the main body 105 may be maintained to be slick.

Alternatively, the support 108a may be a structure that is stored inside the main body 105, and is taken out to the outside of the main body 105 in case the support 108a is needed. In this case, the support groove 104 may be a structure that is led inside the main body 105 to accommodate the support 108a, and the second support surface 108a-2 may include a door that adheres to the outer circumferential surface of the main body 105 or opens or closes the separate support groove 104.

The electronic device 100 may include various kinds of accessories that are helpful in using or storing the electronic device 100. For example, the electronic device 100 may include a protection case for the electronic device 100 to be easily carried while being protected. Alternatively, the electronic device 100 may include a tripod that supports or fixes the main body 105, or a bracket that is coupled to the outer surface of the electronic device 100 and can fix the electronic device 100.

The embodiment 420 in FIG. 4 illustrates a state wherein the electronic device 100 in the embodiment 410 is held to be in contact with the bottom surface.

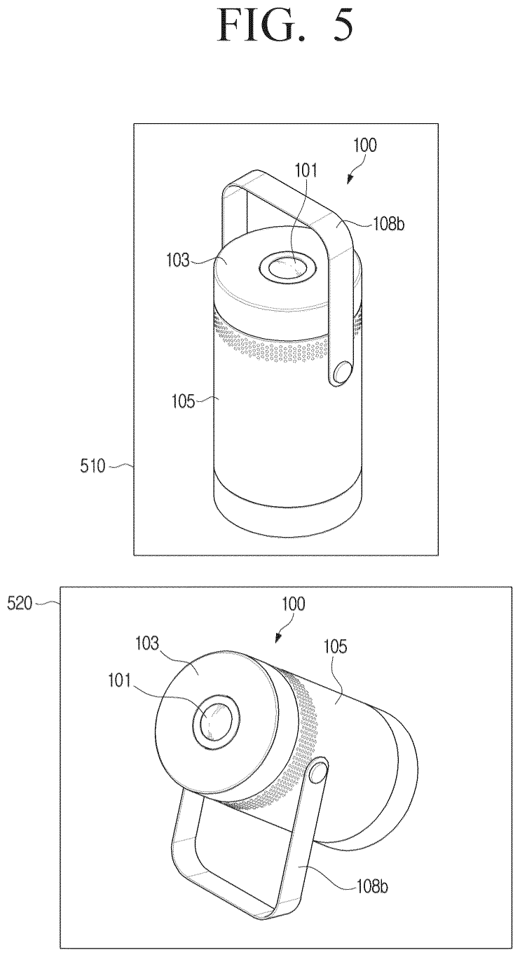

FIG. 5 is a perspective view illustrating an exterior of the electronic device 100 according to one or more embodiments.

Referring to the embodiment 510 in FIG. 5, the electronic device 100 may include a support (or it is referred to as “a handle”) 108b.

The support 108b according to one or more embodiments may be a handle or a ring that is provided for the user to grip or move the electronic device 100. Alternatively, the support 108b may be a stand that supports the main body 105 so as to be toward a certain angle while the main body 105 is laid sideways.

Specifically, the support 108b may be connected with the main body 105 on a predetermined point of the main body 105 (e.g., a ⅔-¾ point of the height of the main body). When the support 108b rotates in the direction of the main body 105, the support 108b may support the main body 105 so as to be toward a certain angle while the main body 105 is laid sideways.

The embodiment 520 in FIG. 5 illustrates a state wherein the electronic device 100 in the embodiment 510 is held to be in contact with the bottom surface.

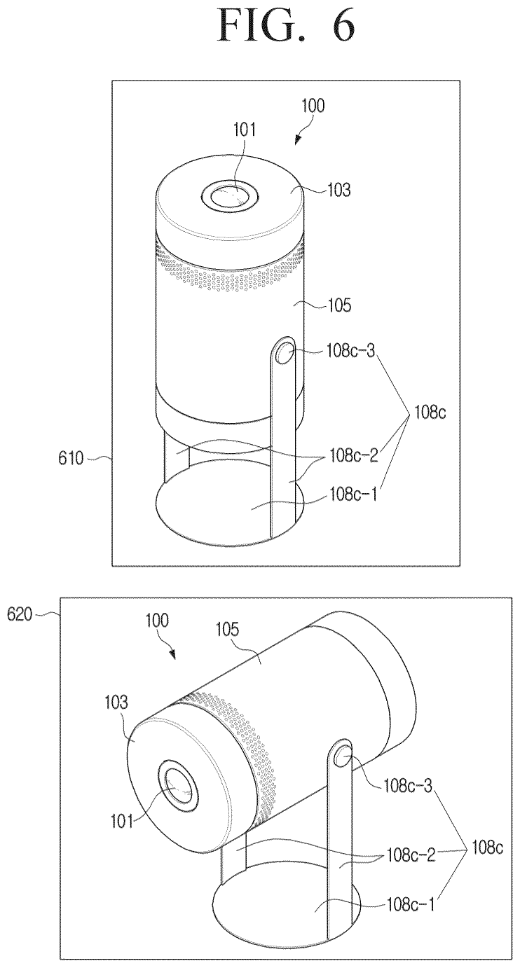

FIG. 6 is a perspective view illustrating an exterior of the electronic device 100 according to one or more embodiments.

Referring to the embodiment 610 in FIG. 6, the electronic device 100 may include a support (or it is referred to as “a prop”) 108c.

The support 108c according to one or more embodiments may include a base plate 108c-1 that is provided to support the electronic device 100 on the ground surface and two support elements 108c-2. Here, the two support elements 108c-2 may connect the base plate 108c-1 and the main body 105.

According to the one or more embodiments of the disclosure, the heights of the two support elements 108c-2 are identical, and each one cross-section of the two support elements 108c-2 may be coupled to or separated from a groove provided on one outer circumferential surface of the main body 105 by a hinge element 108c-3.

The two support elements may be hinge-coupled to the main body 105 on a predetermined point of the main body 105 (e.g., a ⅓- 2/4 point of the height of the main body).

When the two support elements 108c-2 and the main body 105 are coupled by the hinge elements 108c-3, the main body 105 may rotate based on a virtual horizontal axis formed by the two hinge elements 108c-3, and accordingly, the projection angle of the projection lens 101 may be adjusted.

The embodiment 620 in FIG. 6 illustrates a state wherein the electronic device 100 in the embodiment 610 rotated.

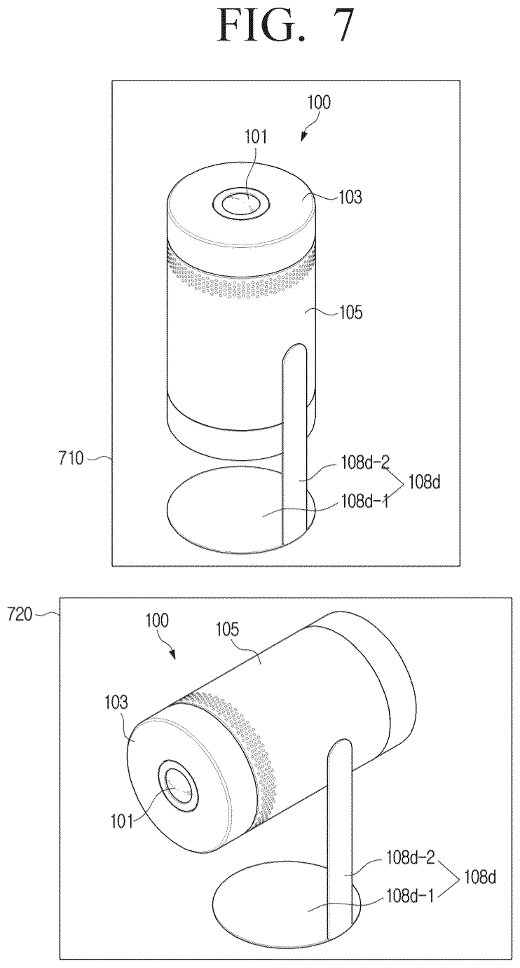

In FIG. 6, an embodiment wherein the two support elements 108c-2 are connected with the main body 105 is illustrated. However, the disclosure is not limited thereto, and one support element and the main body 105 may be connected by one hinge element as in FIG. 7.

FIG. 7 is a perspective view illustrating an exterior of the electronic device 100 according to one or more embodiments.

Referring to the embodiment 710 in FIG. 7, the electronic device 100 may include a support (or it is referred to as “a prop”) 108d.

The support 108d according to one or more embodiments may include a base plate 108d-1 that is provided to support the electronic device 100 on the ground surface and one support element 108d-2 that connects the base plate 108d-1 and the main body 105.

Also, a cross-section of the one support element 108d-2 may be coupled to or separated from a groove provided on one outer circumferential surface of the main body 105 by a hinge element.

When the one support element 108d-2 and the main body 105 are coupled by the one hinge element, the main body 105 may rotate based on a virtual horizontal axis formed by the one hinge element.

The embodiment 720 in FIG. 7 illustrates a state wherein the electronic device 100 in the embodiment 710 rotated.

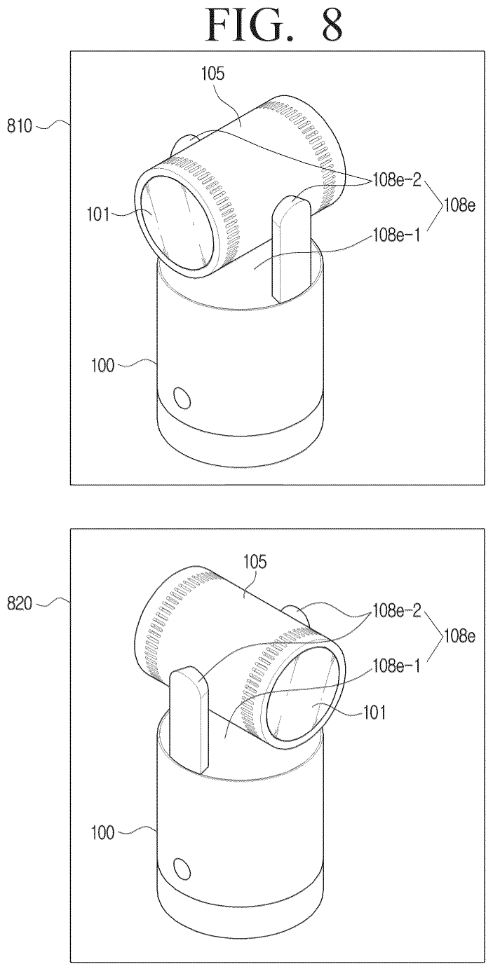

FIG. 8 is a perspective view illustrating an exterior of the electronic device 100 according to one or more embodiments.

Referring to the embodiment 810 in FIG. 8, the electronic device 100 may include a support (or it is referred to as “a prop”) 108e.

The support 108e according to one or more embodiments may include a base plate 108e-1 that is provided to support the electronic device 100 on the ground surface and two support elements 108e-2. Here, the two support elements 108e-2 may connect the base plate 108e-1 and the main body 105.

According to the one or more embodiments of the disclosure, the heights of the two support elements 108e-2 are identical, and each one cross-section of the two support elements 108e-2 may be coupled to or separated from a groove provided on one outer circumferential surface of the main body 105 by a hinge element.

The two support elements may be hinge-coupled to the main body 105 on a predetermined point of the main body 105 (e.g., a ⅓- 2/4 point of the height of the main body).

When the two support elements 108e-2 and the main body 105 are coupled by the hinge elements, the main body 105 may rotate based on a virtual horizontal axis formed by two hinge elements, and accordingly, the projection angle of the projection lens 101 may be adjusted.

Meanwhile, the electronic device 100 may rotate the main body 105 including the projection lens 101. The main body 105 and the support 108e may be rotated based on a virtual vertical axis in the center point of the base plate 108e-1.

The embodiment 820 in FIG. 8 illustrates a state wherein the electronic device 100 in the embodiment 810 rotated.

Meanwhile, the support illustrated in FIG. 4, FIG. 5, FIG. 6, FIG. 7, and FIG. 8 is merely one of various examples, and the electronic device 100 can obviously include a support in various locations and shapes.

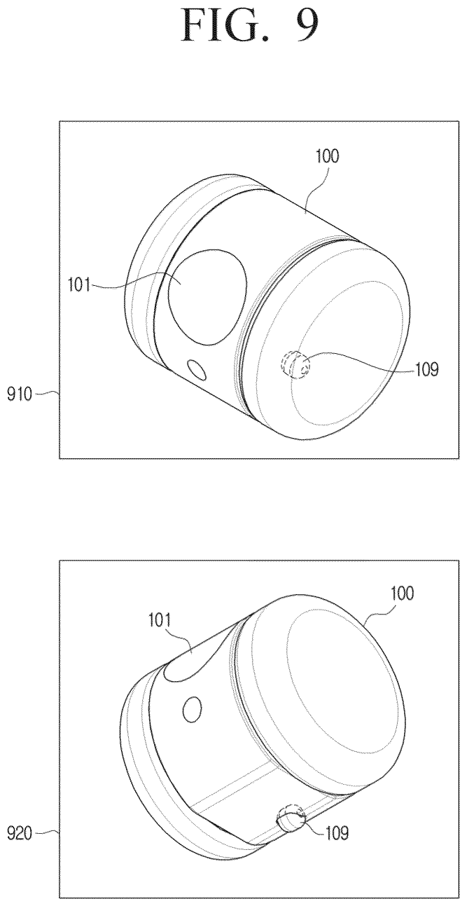

FIG. 9 is a perspective view illustrating an exterior of the electronic device 100 according to one or more embodiments.

Referring to the embodiment 910 in FIG. 9, the electronic device 100 may include a moving element 109. The moving element 109 may mean an element for moving the electronic device 100 from the first position to the second position in the space wherein the electronic device 100 is disposed. The electronic device 100 may control the moving element 109 such that the electronic device 100 is moved by using force generated in the driver 120.

The embodiment 920 in FIG. 9 is a diagram that views the electronic device 100 in the embodiment 910 in a different direction.

FIG. 10 is a diagram for illustrating rotation information of the electronic device 100.

The embodiment 1010 in FIG. 10 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 1020 in FIG. 10 may explain a rotating direction of the electronic device 100 as a rotating direction defined in the embodiment 1010. The x axis rotation information of the electronic device 100 may correspond to a roll of rotating based on the x axis of the electronic device 100. The y axis rotation information of the electronic device 100 may correspond to a pitch of rotating based on the y axis of the electronic device 100. The z axis rotation information of the electronic device 100 may correspond to a yaw of rotating based on the z axis of the electronic device 100.

Meanwhile, the x axis rotation information may also be described as the first axis rotation information, the first axis tilt information, or horizontal warping information. In addition, the y axis rotation information may also be described as the second axis rotation information, the second axis tilt information, or vertical tilt information. Further, the z axis rotation information may also be described as the third axis rotation information, the third axis tilt information, or horizontal tilt information.

Meanwhile, the sensor part 121 may obtain state information (or tilt information) of the electronic device 100. Here, the state information of the electronic device 100 may mean a rotating state of the electronic device 100. Here, the sensor part 121 may include at least one of a gravity sensor, an acceleration sensor, or a gyro sensor. The x axis rotation information of the electronic device 100 and the y axis rotation information of the electronic device 100 may be determined based on sensing data obtained through the sensor part 121.

Meanwhile, the z axis rotation information may be obtained based on how much the electronic device 100 was rotated according to a movement of the electronic device 100.

According to one or more embodiments, the z axis rotation information may indicate how much the electronic device 100 was rotated to the z axis during a predetermined time. For example, the z axis rotation information may indicate how much the electronic device 100 was rotated to the z axis on a second time point based on a first time point.

According to one or more embodiments, the z axis rotation information may indicate an angle between a virtual xz plane from which the electronic device 100 views the projection surface 10 and a virtual plane perpendicular to the projection surface 10. For example, in case the projection surface 10 and the electronic device 100 view each other in a front direction, the z axis rotation information may be 0 degree.

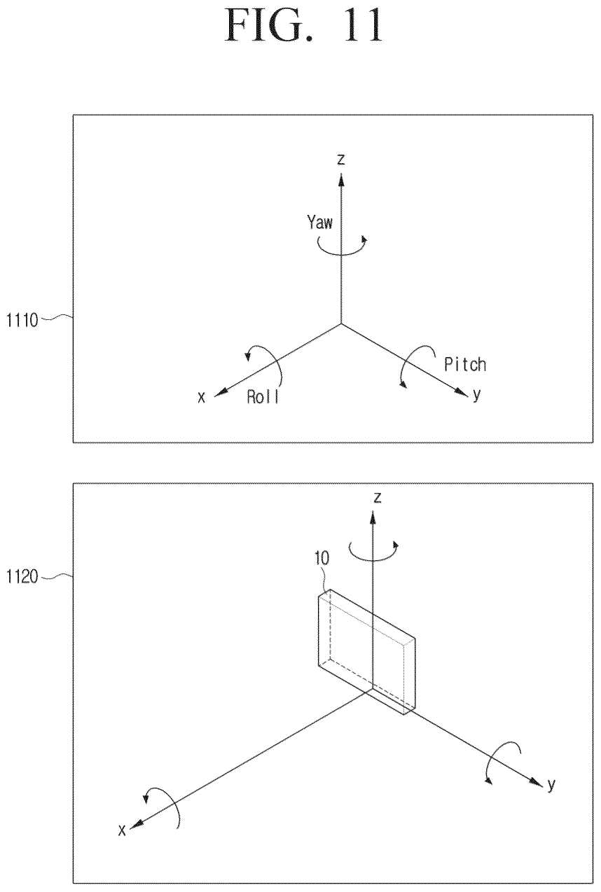

FIG. 11 is a diagram for illustrating rotation information of the projection surface 10.

The embodiment 1110 in FIG. 11 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 1120 in FIG. 11 may explain a rotating direction of the projection surface 10 as a rotating direction defined in the embodiment 1110. The x axis rotation information of the projection surface 10 may correspond to a roll of rotating based on the x axis of the projection surface 10. The y axis rotation information of the projection surface 10 may correspond to a pitch of rotating based on the y axis of the projection surface 10. The z axis rotation information of the projection surface 10 may correspond to a yaw of rotating based on the z axis of the projection surface 10.

Meanwhile, the x axis rotation information may also be described as the first axis rotation information or the first axis tilt information. In addition, the y axis rotation information may also be described as the second axis rotation information or the second axis tilt information. Further, the z axis rotation information may also be described as the third axis rotation information or the third axis tilt information.

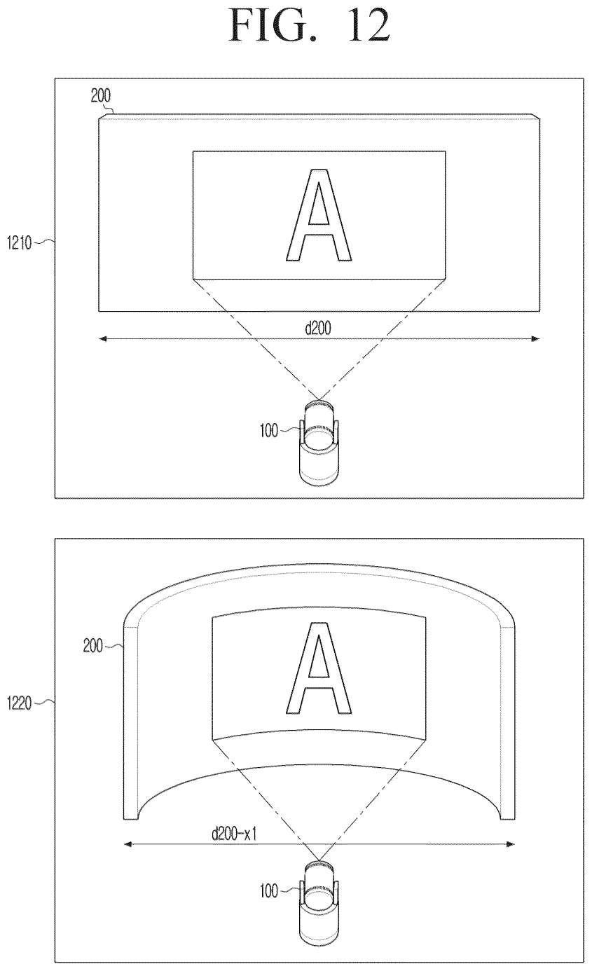

FIG. 12 is a diagram for illustrating an operation of changing a curvature of the screen device 200.

Referring to the embodiment 1210 in FIG. 12, the electronic device 100 may project a projection image on a flat screen device 200. Here, the curvature of the screen device 200 may be 0. In an embodiment wherein the electronic device 100 faces the screen device 200, the electronic device 100 may project a projection image as it is without separate correction. Here, the horizontal length of the screen device 200 will be described as d200.

Referring to the embodiment 1210 in FIG. 12, the electronic device 100 may project a projection image on the screen device 200 in a bent form. Here, the curvature of the screen device 200 may have a value bigger than 0. The screen device 200 may bend a component corresponding to the projection surface based on a specific curvature value. Here, the horizontal length of the screen device 200 may be fixed. Accordingly, in case the curvature of the screen device 200 has a value bigger than 0, the horizontal length of the screen device 200 may have a value smaller than d200 (d200-x1, x1>0). Here, the horizontal length of the screen device 200 may mean the length of a virtual line that connects from the left end portion to the right end portion of the screen device 200.

FIG. 13 is a block diagram illustrating a configuration of the screen device 200 according to one or more embodiments.

Referring to FIG. 13, the screen device 200 may include at least one of at least one processor 211, memory 213, a communication interface 214, a manipulation interface 215, a speaker 217, a microphone 218, a power part 219, a driver 220, or a sensor part 221.

As explanation regarding the components included in the screen device 200 may correspond to the components in FIG. 3, overlapping explanation will be omitted.

Meanwhile, the screen device 200 may include at least one of a screen element 201, a support element 202, a guide element 203-1, 203-2, a motor 204-1, 204-2, or a fixing element 205-1, 205-2. Explanation in this regard will be described in FIG. 51.

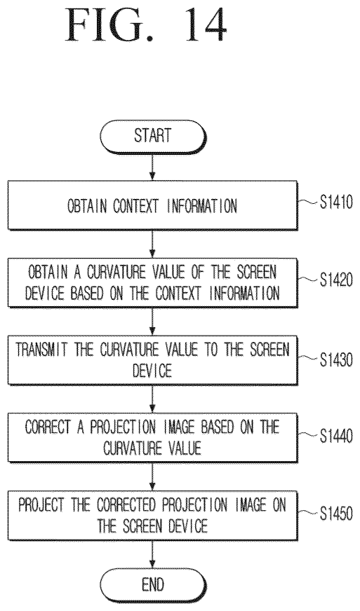

FIG. 14 is a flow chart for illustrating an operation of projecting a projection image based on a curvature value of the screen device 200.

Referring to FIG. 14, the electronic device 100 may obtain context information in operation S1410. Here, the context information may mean various types of information related to the electronic device 100, the screen device 200, and their ambient environment. For example, the context information may include at least one of state information of the electronic device 100 itself, state information of the screen device 200, or environmental information of the ambient space of the electronic device 100 and the screen device 200.

Also, the electronic device 100 may obtain a curvature value of the screen device 200 based on the context information in operation S1420. The electronic device 100 may calculate a curvature value of the screen device 200 that is appropriate for the current context.

Also, the electronic device 100 may transmit the curvature value to the screen device 200 in operation S1430. The electronic device 100 may transmit a control signal (or a control command) for adjusting the curvature of the screen device 200 to the screen device 200.

Further, the electronic device 100 may correct a projection image based on the curvature value in operation S1440. Here, the correcting operation may mean an operation of correcting an image such that a projection image on the bent screen device 200 is not distorted. The image correcting operation may mean keystone correction or leveling correction, etc.

The keystone correction may be an operation of correcting a distorted image according to the state of the electronic device 100 rotated to the z axis or the y axis (refer to FIG. 10). For example, the electronic device 100 may correct an image of a trapezoid form to an image of a rectangular form.

The leveling correction may be an operation of correcting a distorted image according to the state of the electronic device 100 rotated to the x axis (refer to FIG. 10). For example, the electronic device 100 may correct an image that is not parallel to the bottom surface to an image parallel to the bottom surface.

Also, the electronic device 100 may project the corrected projection image on the screen device 200 in operation S1450.

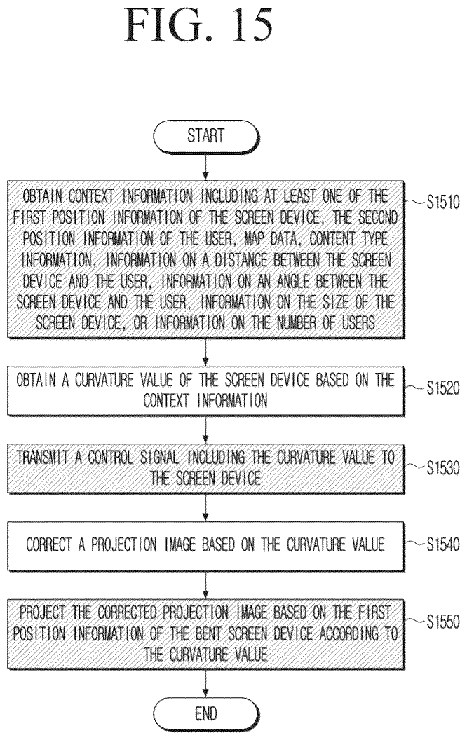

FIG. 15 is a flow chart illustrating in detail the operation in FIG. 14.

The electronic device 100 may obtain context information including at least one of the first position information of the screen device 200, the second position information of the user, map data, content type information, information on a distance between the screen device and the user, information on an angle between the screen device and the user, information on the size of the screen device 200, or information on the number of users in operation S1510.

Meanwhile, the electronic device 100 may additionally obtain the first distance information between the electronic device 100 and the screen device 200 based on the first position information. The electronic device 100 may obtain the second distance information between the electronic device 100 and the user 20 based on the second position information. Then, the electronic device 100 may obtain context information including the first distance information and the second distance information.

Also, the electronic device 100 may obtain a curvature value of the screen device 200 based on the context information in operation S1520.

In addition, the electronic device 100 may transmit a control signal (or a control command) including the curvature value to the screen device 200 in operation S1530.

Further, the electronic device 100 may correct a projection image based on the curvature value in operation S1540.

Also, the electronic device 100 may project the corrected projection image based on the first position information of the bent screen device 200 according to the curvature value in operation S1550. The screen device 200 may be bent based on the curvature value received from the electronic device 100. The electronic device 100 may project the projection image toward the position of the screen device 200.

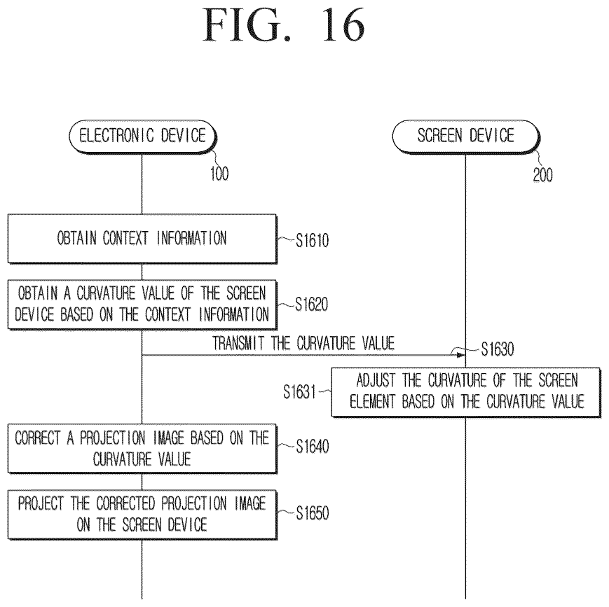

FIG. 16 is a flow chart for illustrating an operation of adjusting a curvature of the screen device 200 and projecting a projection image through the electronic device 100.

The operations S1610, S1620, S1630, S1640, and S1650 in FIG. 16 may correspond to the operations S1410, S1420, S1430, S1440, and S1450 in FIG. 14. Accordingly, overlapping explanation will be omitted.

After the operation S1630 wherein the electronic device 100 transmits a curvature value to the screen device 200, the screen device 200 may receive the curvature value from the electronic device 100. Then, the screen device 200 may adjust (or change) the curvature of the screen element based on the curvature value received from the electronic device 100 in operation S1631.

FIG. 17 is a diagram for illustrating position information of the screen device 200.

Referring to the embodiment 1710 in FIG. 17, the position (or the central position) of the screen device 200 may be p1. The first position information of the screen device 200 may include p1. Then, the electronic device 100 may obtain a distance d1 between the position p0 of the electronic device 100 and the position p1 of the screen device 200 based on the first position information.

Referring to the embodiment 1720 in FIG. 17, the height of the central position p1 of the screen device 200 and the height of the position p0 of the electronic device 100 may be different. The distance between the position p0 of the electronic device 100 and the central position p1 of the screen device 200 may be d1, and the horizontal distance between the position p0 of the electronic device 100 and the screen device 200 may be da. The electronic device 100 may identify the degree of rotation with respect to the y axis (refer to FIG. 10) based on the first position information of the screen device 200. The electronic device 100 may obtain a rotated angle θa based on the y axis. The electronic device 100 may correct a projection image on the basis of the rotated angle θa based on the y axis.

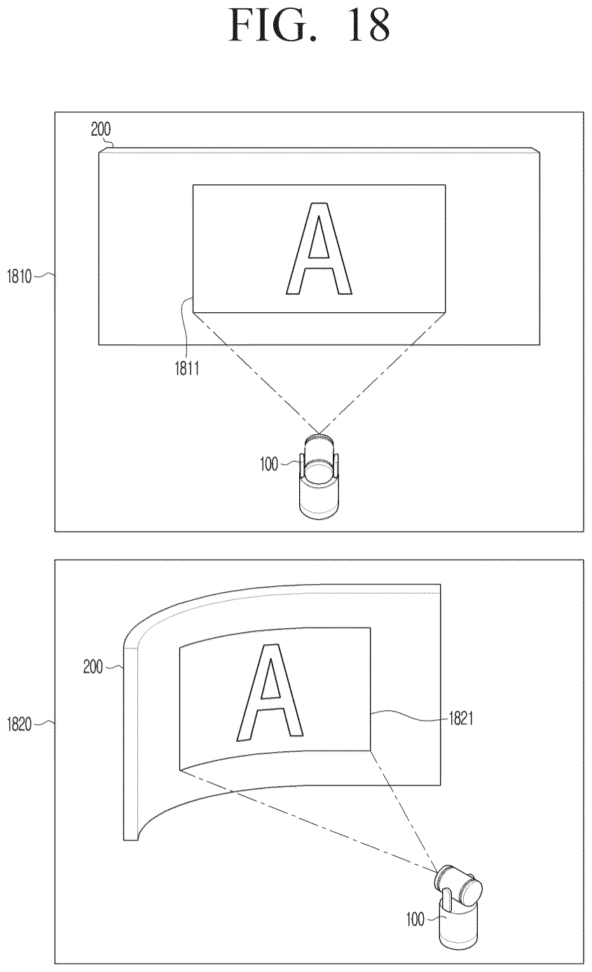

FIG. 18 is a diagram for illustrating an operation of projecting a projection image according to adjustment of a curvature of the screen device 200.

Referring to FIG. 18, the electronic device 100 may determine a curvature value of the screen device 200 based on the first position information of the screen device 200. The electronic device 100 may obtain information on the angle between the electronic device 100 and the screen device 200 based on the first position information of the screen device 200. Here, the angle information may be θ1 described in the embodiment 3110 in FIG. 31. The electronic device 100 may determine the curvature value of the screen device 200 based on the angle information θ1 between the electronic device 100 and the screen device 200.

Referring to the embodiment 1810 in FIG. 18, the electronic device 100 may obtain a curvature value based on the first position information of the screen device 200. In case the electronic device 100 and the screen device 200 face each other, the electronic device 100 may determine the curvature value of the screen device 200 as 0. The electronic device 100 may transmit the curvature value 0 to the screen device 200, and the screen device 200 may control the curvature of the screen device 200 according to the curvature value 0. The electronic device 100 may project a projection image 1811 on the screen device 200 constituting a plane according to the curvature value 0.

Referring to the embodiment 1820 in FIG. 18, in case the electronic device 100 and the screen device 200 do not face each other, the electronic device 100 may determine the curvature value of the screen device 200 as a value b bigger than 0. The electronic device 100 may transmit the curvature value b to the screen device 200, and the screen device 200 may control the curvature of the screen device 200 according to the curvature value b. The electronic device 100 may project a projection image 1821 on the bent screen device 200 according to the curvature value b. Here, the projection image 1821 may mean an image that was corrected according to the curvature value b of the screen device 200.

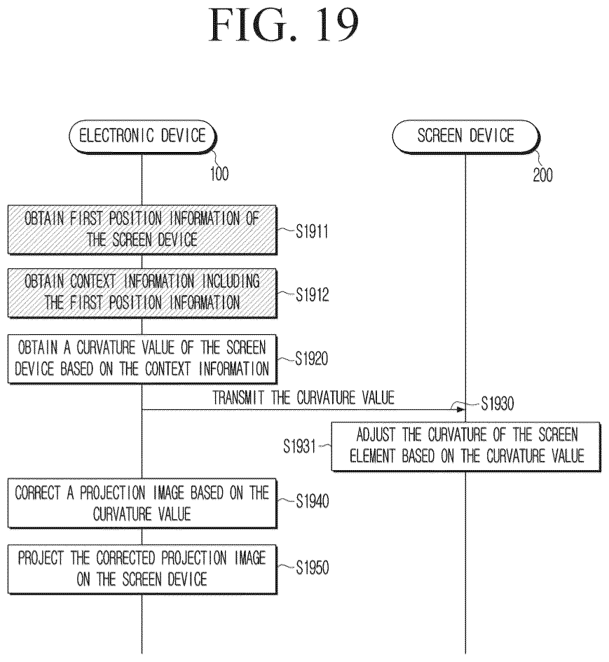

FIG. 19 is a flow chart for illustrating an operation of obtaining a curvature value based on context information including first position information.

The operations S1920, S1930, S1931, S1940, and S1950 in FIG. 19 may correspond to the operations S1620, S1630, S1631, S1640, and S1650 in FIG. 16. Accordingly, overlapping explanation will be omitted.

The electronic device 100 may obtain the first position information of the screen device 200 in operation S1911. Then, the electronic device 100 may obtain context information including the first position information of the screen device 200 in operation S1912. Then, the electronic device 100 may perform the operations S1920 to S1950.

FIG. 20 is a diagram for illustrating an operation of identifying position information of the screen device 200 based on sensing data.

Referring to FIG. 20, the electronic device 100 may obtain sensing data indicating the position of the screen device 200 through the sensor part 121. Here, the sensing data may mean data that was obtained through a distance sensor included in the sensor part 121. Here, the distance sensor may mean an infrared or a Time of Flight (ToF) sensor. According to one or more embodiments, the sensing data may mean data that was obtained through an image sensor.

Here, the electronic device 100 may obtain the first position information of the screen device 200 by analyzing the sensing data. Then, the electronic device 100 may obtain context information including the first position information of the screen device 200.

FIG. 21 is a flow chart for illustrating an operation of identifying position information of the screen device 200 based on sensing data.

The operations S2112, S2120, S2130, S2131, S2140, and S2150 in FIG. 21 may correspond to the operations S1912, S1920, S1930, S1931, S1940, and S1950 in FIG. 19. Accordingly, overlapping explanation will be omitted.

The electronic device 100 may transmit a position request signal to the screen device 200 for identifying the position of the screen device 200 in operation S2111-1. Here, the position request signal may also be described as a control signal for requesting the position of the screen device 200.

The screen device 200 may receive the position request signal from the electronic device 100. Then, the screen device 200 may transmit a position response signal corresponding to the position request signal to the electronic device 100 in operation S2111-2.

The electronic device 100 may receive the position response signal from the screen device 200. Then, the electronic device 100 may obtain the first position information of the screen device 200 based on the position response signal received from the screen device 200 in operation S2111-3. Afterwards, the electronic device 100 may perform the operations S2112 to S2150.

FIG. 22 is a diagram for illustrating an operation of adjusting a curvature of the screen device 200 based on a user position.

Referring to FIG. 22, the electronic device 100 may identify the position of the user 20 based on sensing data obtained through the sensor part 121. Here, the second position information may include information indicating the position of the user 20. Here, the sensing data may mean data that was obtained through the distance sensor included in the sensor part 121. Here, the distance sensor may mean an infrared or a Time of Flight (ToF) sensor. According to one or more embodiments, the sensing data may mean data that was obtained through an image sensor.

Meanwhile, according to one or more embodiments, a position request signal and a position response signal may be used as in FIG. 21 in identifying the position of the user 20. For example, it is assumed that the user 20 possesses a terminal device 300 that can communicate with the electronic device 100. The electronic device 100 may transmit a position request signal to the terminal device 300. The terminal device 300 may transmit a position response signal to the electronic device 100. The electronic device 100 may identify the position of the user 20 based on the position response signal received from the terminal device 300.

Meanwhile, the electronic device 100 may obtain a curvature value of the screen device 200 in consideration of the position of the user 20. The curvature of the screen device 200 may vary according to the position of the user 20. The screen device 200 may be bent in consideration of the position of the user 20. The electronic device 100 may obtain the curvature value of the screen device 200 such that a portion close to the position of the user 20 among the entire areas of the screen device 200 has a smaller curvature value, and a portion far from the position of the user 20 among the entire areas of the screen device 200 has a bigger curvature value.

Referring to the embodiment 2210 in FIG. 22, the user 20 may stand on the right side based on the direction in which the electronic device 100 is toward the screen device 200. Accordingly, based on the direction in which the electronic device 100 is toward the screen device 200, the curvature value of the right portion of the screen device 200 may be smaller than that of the left portion of the screen device 200.

Referring to the embodiment 2220 in FIG. 22, the user 20 may stand on the left side based on the direction in which the electronic device 100 is toward the screen device 200. Accordingly, based on the direction in which the electronic device 100 is toward the screen device 200, the curvature value of the left portion of the screen device 200 may be smaller than that of the right portion of the screen device 200.

The position of the user 20 in the embodiment 2210 is opposite to the position of the user 20 in the embodiment 2220, and thus the direction in which the screen device 200 is bent in the embodiment 2210 may be opposite to the direction in which the screen device 200 is bent in the embodiment 2220.

FIG. 23 is a flow chart for illustrating an operation of adjusting a curvature of the screen device 200 based on a user position.

The operations S2320, S2330, S2331, S2340, and S2350 in FIG. 23 may correspond to the operations S1620, S1630, S1631, S1640, and S1650 in FIG. 16. Accordingly, overlapping explanation will be omitted.

The electronic device 100 may obtain the first position information of the screen device 200 in operation S2311. The electronic device 100 may obtain the first position information indicating the position of the screen device 200 based on sensing data obtained through the sensor part 121 or a position response signal obtained from the screen device 200.

Also, the electronic device 100 may obtain the second position information of the user 20 in operation S2312. The electronic device 100 may obtain the second position information indicating the position of the user 20 based on sensing data obtained through the sensor part 121 or a position response signal obtained from the terminal device 300 of the user.

Then, the electronic device 100 may obtain context information including the first position information and the second position information in operation S2313.

Afterwards, the electronic device 100 may perform the operations S2320 to S2350.

FIG. 24 is a diagram for illustrating map data indicating a position of the screen device 200 and a position of a user.

Referring to FIG. 24, the electronic device 100 may obtain (or generate) map data based on the first position information of the screen device 200 and the second position information of the user 20. Here, the map data may mean two-dimensional or three-dimensional data. FIG. 24 represents two-dimensional map data for the convenience of explanation. Here, the electronic device 100 may obtain context information based on the obtained map data.

p1 indicates the position of the screen device 200. p2 indicates the position of the user 20. The distance between the electronic device 100 and the screen device 200 may be d1. The distance between the electronic device 100 and the user 20 may be d2. The distance between the screen device 200 and the user 20 may be d3.

The map data illustrated in the embodiment 2410 in FIG. 24 may correspond to the embodiment 2210 in FIG. 22. p0 indicates the position of the electronic device 100.

The map data illustrated in the embodiment 2420 in FIG. 24 may correspond to the embodiment 2220 in FIG. 22. p0 indicates the position of the electronic device 100.

FIG. 25 is a flow chart for illustrating an operation of adjusting a curvature of the screen device 200 based on map data indicating a position of the screen device 200 and a position of a user.

The operations S2511, S2512, S2520, S2530, S2531, S2540, and S2550 in FIG. 25 may correspond to the operations S2311, S2312, S2320, S2330, S2331, S2340, and S2350 in FIG. 23. Accordingly, overlapping explanation will be omitted.

After obtaining the first position information and the second position information, the electronic device 100 may obtain map data based on the first position information and the second position information in operation S2513. Then, the electronic device 100 may obtain context information including map data in operation S2514. The electronic device 100 may obtain context information in consideration of at least one of the position of the electronic device 100, the position of the screen device 200, or the position of the user 20 included in the map data.

Afterwards, the electronic device 100 may perform the operations S2520 to S2550.

FIG. 26 is a diagram for illustrating an operation of adjusting a curvature of the screen device 200 based on content type information.

Referring to FIG. 26, the electronic device 100 may adjust a curvature value of the screen device 200 according to the type of a content provided to the user.

Referring to the embodiment 2610 in FIG. 26, in case a content provided to the user is not a predetermined content type, the electronic device 100 may perform control such that the screen device 200 is maintained as a plane.

Referring to the embodiment 2620 in FIG. 26, in case a content provided to the user is a predetermined content type, the electronic device 100 may perform control such that the screen device 200 is bent. Here, the predetermined content type may mean a game content or a movie content. Meanwhile, according to one or more embodiments, the predetermined content type may be changed according to the user's setting.

FIG. 27 is a flow chart for illustrating an operation of adjusting a curvature of the screen device 200 based on content type information.

The operations S2711, S2712, S2720, S2730, S2731, S2740, and S2750 in FIG. 27 may correspond to the operations S2311, S2312, S2320, S2330, S2331, S2340, and S2350 in FIG. 23. Accordingly, overlapping explanation will be omitted.

After obtaining the first position information and the second position information, the electronic device 100 may obtain content type information in operation S2713. Then, the electronic device 100 may obtain context information including the first position information, the second position information, and the content type information in operation S2714.

Afterwards, the electronic device 100 may perform the operations S2720 to S2750.

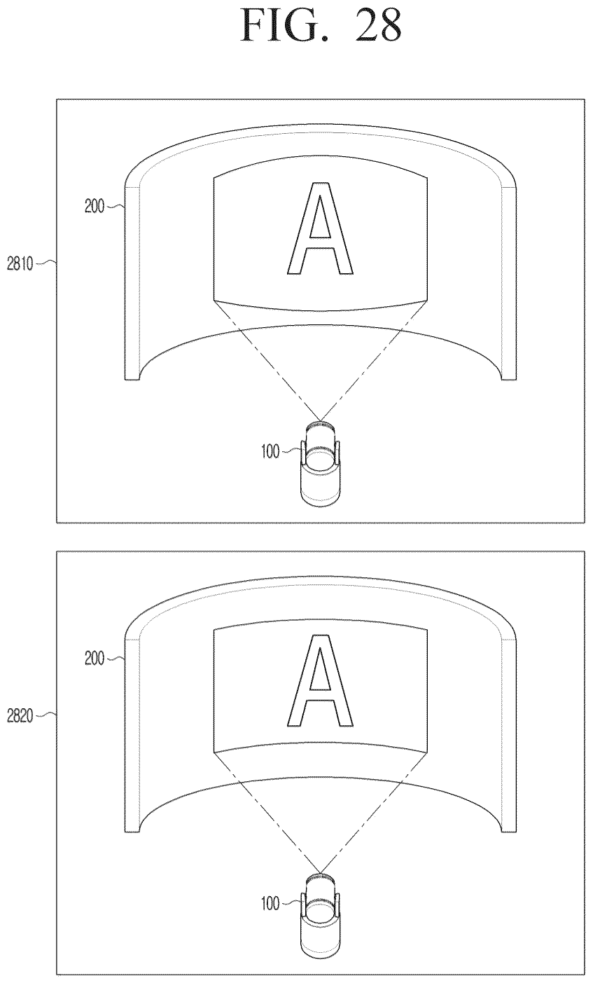

FIG. 28 is a diagram for illustrating an operation of correcting an image according to a curvature of the screen device 200.

Referring to the embodiment 2810 in FIG. 28, the electronic device 100 may project a general projection image on the bent screen device 200. In case a general projection image is projected on the bent screen device 200, the projection image may not be seen in a rectangular form, but may be seen in a distorted form to the user.

Referring to the embodiment 2820 in FIG. 28, the electronic device 100 may correct a projection image for resolving a phenomenon wherein an image in a distorted form is provided to the user. The electronic device 100 may project the corrected projection image on the bent screen device 200. In case the corrected projection image is projected on the bent screen device 200, the projection image may be seen in a rectangular form to the user.

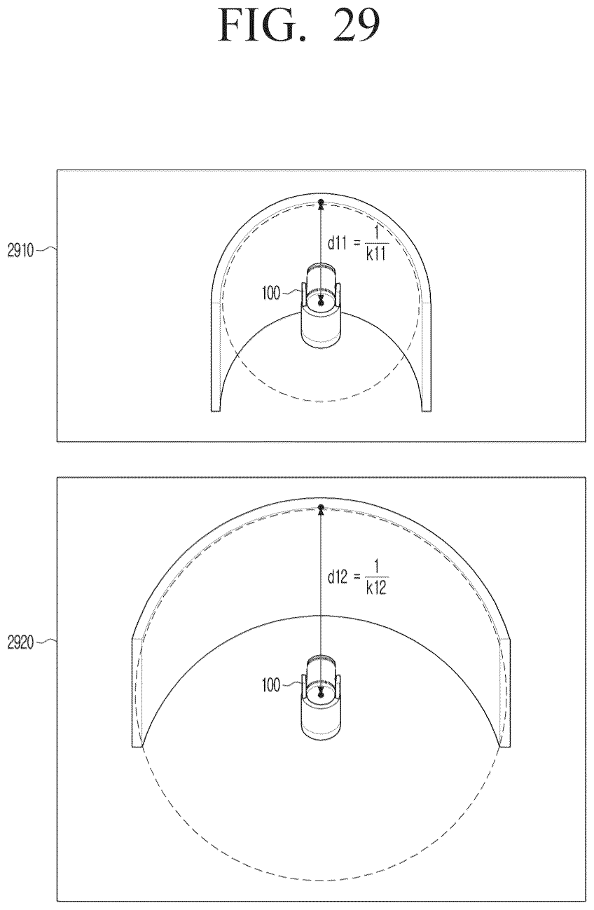

FIG. 29 is a diagram for illustrating a curvature radius of the screen device 200 based on a relative position of the electronic device 100.

Referring to FIG. 29, the electronic device 100 may determine a curvature value of the screen device 200 in consideration of the position of the screen device 200. As the distance between the electronic device 100 and the screen device 200 is farther, the curvature value of the screen device 200 may become smaller.

Referring to the embodiment 2910 in FIG. 29, the distance between the electronic device 100 and the screen device 200 may be d11. Here, the electronic device 100 may determine d11 as the curvature radius of the screen device 200. The curvature and the curvature radius may be in a reciprocal relationship. Accordingly, the curvature k11 of the screen device 200 may be 1/d11.

Referring to the embodiment 2920 in FIG. 29, the distance between the electronic device 100 and the screen device 200 may be d12. Here, the electronic device 100 may determine d12 as the curvature radius of the screen device 200. The curvature and the curvature radius may be in a reciprocal relationship. Accordingly, the curvature k12 of the screen device 200 may be 1/d12.

In case d11 in the embodiment 2910 is smaller than d12 in the embodiment 2920, k11 in the embodiment 2910 may be bigger than k12 in the embodiment 2920.

FIG. 30 is a diagram for illustrating a curvature radius of the screen device 200 based on a position of a user.

Referring to FIG. 30, the electronic device 100 may determine a curvature value of the screen device 200 in consideration of the position of the user 20. The distance between the position p1 of the screen device 200 and the position p2 of the user 20 may be d3. Here, the electronic device 100 may determine d3 as the curvature radius of the screen device 200. Accordingly, the curvature value of the screen device 200 may be 1/d3.

FIG. 31 is a diagram for illustrating an operation of calculating a curvature value and a projection ratio.

The embodiment 3110 in FIG. 31 indicates map data including the position p0 of the electronic device 100, the position p1 of the screen device 200, and the position p2 of the user 20.

p1 indicates the position of the screen device 200. p2 indicates the position of the user 20. The distance between the electronic device 100 and the screen device 200 may be d1. The distance between the electronic device 100 and the user 20 may be d2. The distance between the screen device 200 and the user 20 may be d3.

θ1 may mean an angle between a virtual line 31-0 connecting from the position p0 of the electronic device 100 to the closest position to the electronic device 100 in the screen device 200 and a virtual line 31-1 connecting from the position p0 of the electronic device 100 to the position p1 of the screen device 200.

θ2 may mean an angle between a virtual line 31-1 connecting from the position p0 of the electronic device 100 to the position p1 of the screen device 200 and a virtual line 31-2 connecting from the position p0 of the electronic device 100 to the position p2 of the user 20. Here, θ2 may be an angle between the screen device 200 and the user 20 based on the direction in which the electronic device 100 faces the screen device 200.

θ3 may mean an angle between a virtual line 31-3 connecting from the position p2 of the user 20 to the position p1 of the screen device 200 and a virtual line 31-4 parallel to the horizontal surface of the screen device 200. Here, the horizontal surface of the screen device 200 may mean the y-z axis plane in FIG. 11. Here, θ3 may be an angle between the screen device 200 and the user 20 based on the direction in which the user 20 faces the screen device 200.

The angle information between the electronic device 100 and the screen device 200 may include θ1.

The angle information between the screen device 200 and the user 20 may include at least one of θ2 or θ3.

Meanwhile, the electronic device 100 may calculate a distance d3 from the position p2 of the user 20 to the position p1 of the screen device 200 based on a formula 3120. The electronic device 100 may calculate the distance d3 based on the distance d1, the distance d2, and the angle θ2. Here, the distance d3 may be obtained.

Meanwhile, the electronic device 100 may calculate a curvature value k of the screen device 200 based on a formula 3130. The electronic device 100 may obtain the curvature value k based on functions f1, f2, f3 having weights w1, w2, w3, the distances d1, d2, d3, and the angles θ1, θ2, θ3 as factors.

Meanwhile, according to a formula 3140, the curvature value k may be proportional to the angle θ1, and may be inversely proportional to the distances d1, d2, d3 and the angle θ3.

As the electronic device 100 faces the center of the screen device 200 in a more frontal direction as the angle θ1 is smaller, the curvature value k may become smaller. Meanwhile, as the curvature radius may become bigger as the distances d1, d2, d3 are bigger, the curvature value k may become smaller. Also, as the user 20 faces the center of the screen device 200 in a more frontal direction as the angle θ3 becomes bigger, the curvature value k may become smaller.

Meanwhile, the electronic device 100 may calculate a projection ratio based on a formula 3150. The electronic device 100 may obtain a projection ratio based on a projection distance and the horizontal length of a projection area. Here, the projection distance may mean the distance d1 from the position p0 of the electronic device 100 to the position p1 of the screen device 200. Here, the horizontal length of the projection area may mean the horizontal length d200 of the screen device 200.

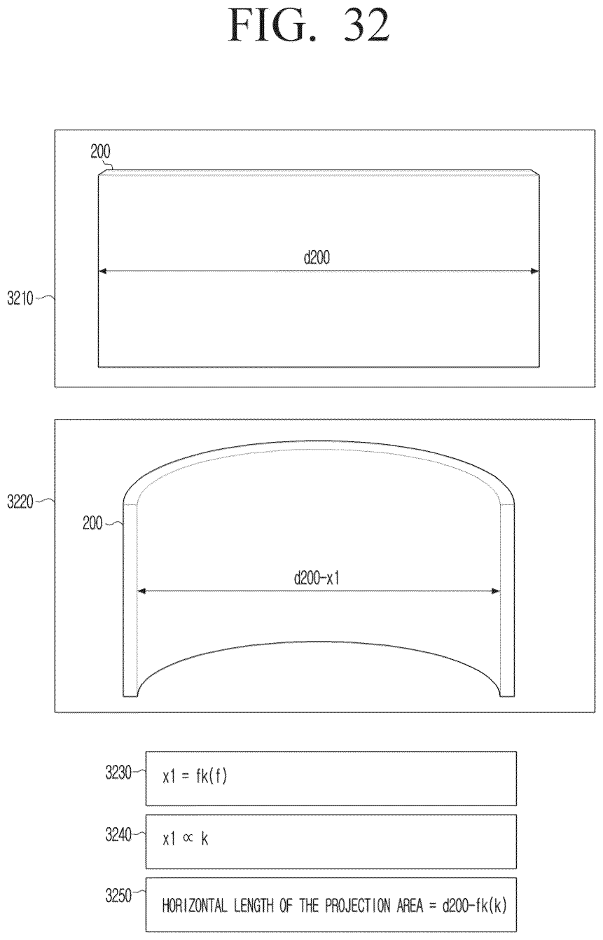

FIG. 32 is a diagram for illustrating a horizontal length of a projection area that is changed according to a curvature of the screen device 200.

Referring to the embodiment 3210 in FIG. 32, if the curvature value of the screen device 200 is 0, the horizontal length of the screen device 200 may be d200.

Referring to the embodiment 3220 in FIG. 32, if the curvature value of the screen device 200 is bigger than 0, the horizontal length of the screen device 200 may be smaller than d200. Here, the horizontal length of the screen device 200 may be described as d200-x1. Here, x1 may mean a value bigger than 0.

Meanwhile, the electronic device 100 may obtain the x1 value based on a formula 3230. x1 may be obtained based on a predetermined function fk having the curvature value k as a factor.

Meanwhile, according to a formula 3240, x1 may be proportional to the curvature value k. As the curvature value k is bigger, x1 may become bigger, and the horizontal length d200-x1 of the screen device 200 may become smaller. As the curvature value k is smaller, x1 may become smaller, and the horizontal length d200-x1 of the screen device 200 may become bigger.

Meanwhile, the electronic device 100 may obtain the horizontal length of a projection area based on a formula 3250. The horizontal length of the projection area may be calculated as a value which is a result of subtracting fk (k) from d200.

FIG. 33 is a flow chart for illustrating an operation of adjusting a curvature of the screen device 200 based on a relation between the screen device 200 and a user.

The operations S3311, S3312, S3320, S3330, S3331, S3340, and S3350 in FIG. 33 may correspond to the operations S2311, S2312, S2320, S2330, S2331, S2340, and S2350 in FIG. 23. Accordingly, overlapping explanation will be omitted.

After obtaining the first position information and the second position information, the electronic device 100 may obtain distance information between the screen device 200 and the user 20 and angle information between the screen device 200 and the user 20 based on the first position information and the second position information in operation S3313. Here, the distance information may include d3 in FIG. 31. Here, the angle information may include θ3 in FIG. 31.

Also, the electronic device 100 may obtain context information including the first position information, the second position information, the distance information between the screen device 200 and the user 20, and the angle information between the screen device 200 and the user 20 in operation S3314.

Afterwards, the electronic device 100 may perform the operations S3320 to S3350.

FIG. 34 is a flow chart for illustrating an operation of obtaining a projection ratio based on size information of the screen device 200.

The operations S3411, S3412, S3420, S3430, S3431, and S3440 in FIG. 34 may correspond to the operations S2311, S2312, S2320, S2330, S2331, and S2340 in FIG. 23. Accordingly, overlapping explanation will be omitted.

After obtaining the first position information and the second position information, the electronic device 100 may obtain the size information of the screen device 200 in operation S3413. Then, the electronic device 100 may obtain context information including the first position information, the second position information, and the size information of the screen device 200 in operation S3414. Here, the size information of the screen device 200 may include the horizontal length of the screen device 200.

Afterwards, the electronic device 100 may perform the operations S3420 to S3440.

After a projection image is corrected, the electronic device 100 may obtain distance information between the electronic device 100 and the screen device 200 based on the first position information in operation S3451. Here, the distance information may include d1 in FIG. 31.

Also, the electronic device 100 may obtain a projection ratio based on at least one of the size information of the screen device 200 or the distance information between the electronic device 100 and the screen device 200 in operation S3452.

Further, the electronic device 100 may project the projection image corrected based on the projection ratio on the screen device 200 in operation S3453.

FIG. 35 is a diagram for illustrating an operation of correcting a projection image according to one or more embodiments.

Referring to the embodiment 3510 in FIG. 35, the electronic device 100 may project a general projection image 3511 on the bent screen device 200. Here, the projected image 3512 may be seen in a distorted form to the user.

Referring to the embodiment 3520 in FIG. 35, the electronic device 100 may project a corrected projection image 3521 on the bent screen device 200. Here, the projected image 3522 may be seen in an undistorted form to the user.

The electronic device 100 may correct a projection image based on the distance between the electronic device 100 and a projection area. The electronic device 100 may correct an image such that the unit size of the image is reduced more as the distance between the electronic device 100 and the projection area is farther.

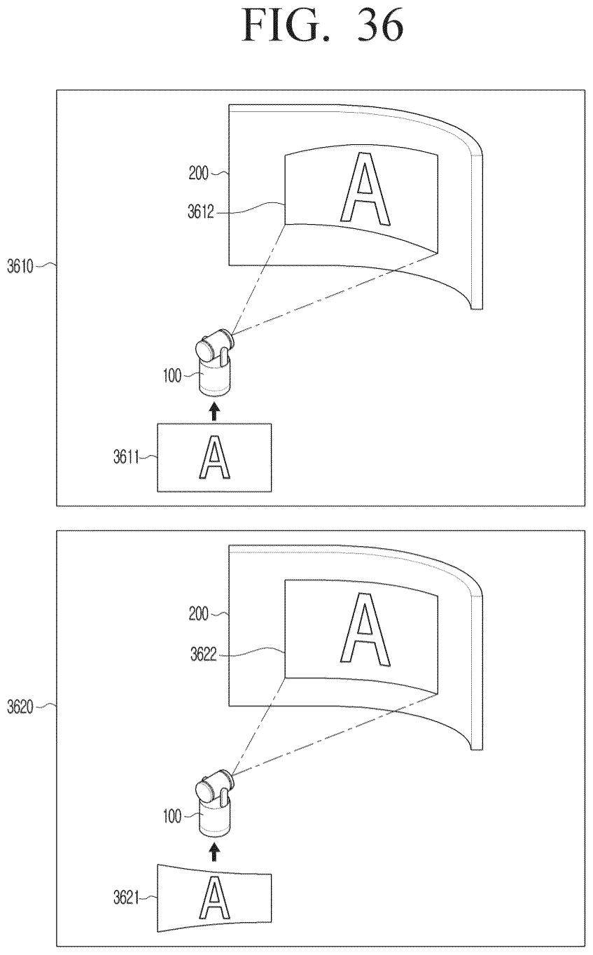

FIG. 36 is a diagram for illustrating an operation of correcting a projection image according to one or more embodiments.

Referring to the embodiment 3610 in FIG. 36, the electronic device 100 may project a general projection image 3611 on the bent screen device 200. Here, the projected image 3612 may be seen in a distorted form to the user.

Referring to the embodiment 3620 in FIG. 36, the electronic device 100 may project a corrected projection image 3621 on the bent screen device 200. Here, the projected image 3622 may be seen in an undistorted form to the user.

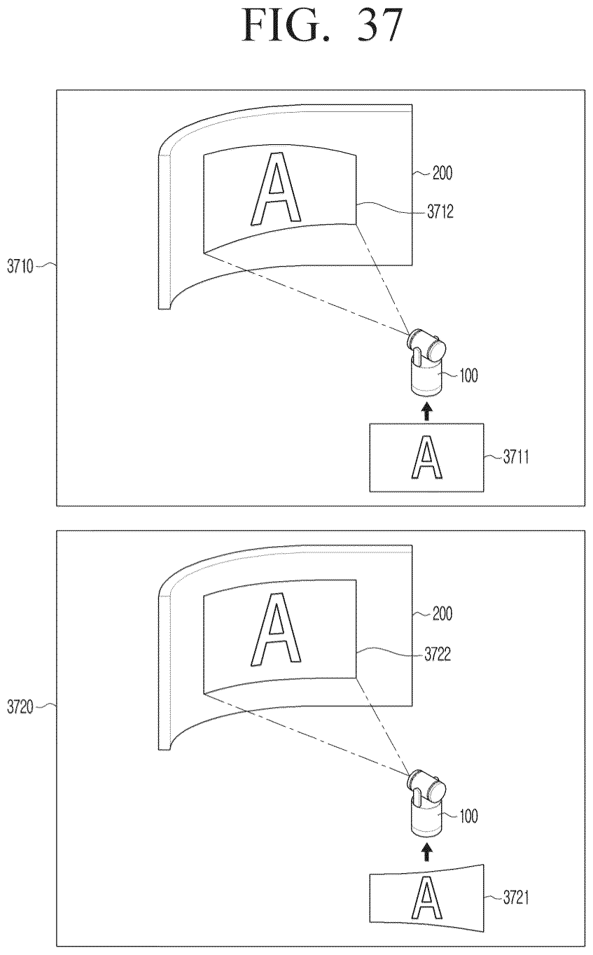

FIG. 37 is a diagram for illustrating an operation of correcting a projection image according to one or more embodiments.

Referring to the embodiment 3710 in FIG. 37, the electronic device 100 may project a general projection image 3711 on the bent screen device 200. Here, the projected image 3712 may be seen in a distorted form to the user.

Referring to the embodiment 3720 in FIG. 37, the electronic device 100 may project a corrected projection image 3721 on the bent screen device 200. Here, the projected image 3722 may be seen in an undistorted form to the user.

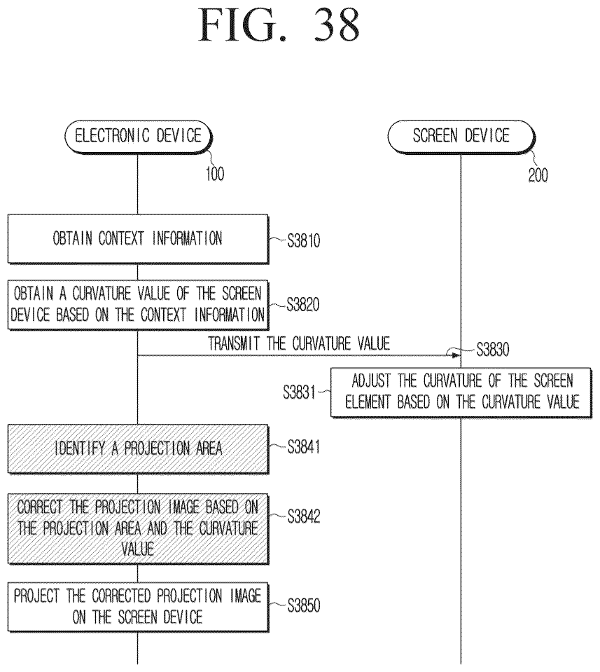

FIG. 38 is a flow chart for illustrating an operation of correcting a projection image based on a projection area.

The operations S3810, S3820, S3820, S3830, S3831, and S3850 in FIG. 38 may correspond to the operations S1610, S1620, S1620, S1630, S1631, and S1650 in FIG. 16. Accordingly, overlapping explanation will be omitted.

After obtaining a curvature value, the electronic device 100 may identify a projection area in operation S3841. Here, the projection area may mean an area wherein it is identified that a projection image is projected among the entire areas of the screen device 200.

Also, the electronic device 100 may correct the projection image based on the projection area and the curvature value in operation S3842. Here, the electronic device 100 may correct the projection image for providing an undistorted image to the user based on the position of the projection area and the curvature value.

Afterwards, the electronic device 100 may perform the operation S3850.

FIG. 39 is a diagram for illustrating an operation of correcting a projection image by dividing a projection area.

Referring to the embodiment 3910 in FIG. 39, the electronic device 100 may identify a projection area. Then, the electronic device 100 may divide the identified projection area in predetermined units. In the embodiment 3910, it is assumed that the projection area is divided into nine areas. The electronic device 100 may obtain positions pi1, pi2, pi3, pi4, pi5, pi6, pi7, pi8, pi9 representing each of the divided nine areas. Then, the electronic device 100 may obtain distances di1, di2, di3, di4, di5, di6, di7, di8, di9 from the position p0 of the electronic device 100 to the positions of each of the divided areas pi1, pi2, pi3, pi4, pi5, pi6, pi7, pi8, pi9.

Then, the electronic device 100 may correct the projection image based on the distances di1, di2, di3, di4, di5, di6, di7, di8, di9. The electronic device 100 may correct the image size to be smaller as the distance value is bigger. For example, if the distance di1 from p0 to pi1 is bigger than the distance di5 from p0 to pi5, the electronic device 100 may correct the projection image such that the size of the image area corresponding to pi1 is bigger than the size of the image area corresponding to pi5.

Referring to the embodiment 3920 in FIG. 39, the electronic device 100 may project the corrected projection image on the bent screen device 200.

FIG. 40 is a flow chart for illustrating an operation of correcting a projection image by dividing a projection area.

The operations S4010, S4020, S4030, S4031, S4041, and S4050 in FIG. 40 may correspond to the operations S3810, S3820, S3830, S3831, S3841, and S3850 in FIG. 38. Accordingly, overlapping explanation will be omitted.

After identifying a projection area, the electronic device 100 may divide the projection area into groups of predetermined units in operation S4042. Here, the sizes and the number of the groups of the predetermined units may be changed according to the user's setting.

Also, the electronic device 100 may obtain distance information between each of the divided groups and the electronic device 100 based on the curvature value in operation S4043. Here, the distance information may include di1, di2, di3, di4, di5, di6, di7, di8, di9 in FIG. 39.

Also, the electronic device 100 may correct projection images corresponding to each of the divided groups based on the distance information between each of the divided groups and the electronic device 100 in operation S4044.

Afterwards, the electronic device 100 may perform the operation S4050.

FIG. 41 is a diagram for illustrating an operation of adjusting a curvature of the screen device 200 through the terminal device 300 according to one or more embodiments.

Referring to FIG. 41, the curvature of the screen device 200 may be adjusted based on a user input received from the terminal device 300.

The electronic device 100, the screen device 200, and the terminal device 300 may be communicatively connected with one another.

According to one or more embodiments, the screen device 200 and the terminal device 300 may not be communicatively connected. The terminal device 300 may only be communicatively connected with the electronic device 100, and may not be communicatively connected with the screen device 200.

Also, according to one or more embodiments, the electronic device 100 and the screen device 200 may not be communicatively connected. The terminal device 300 may only be communicatively connected with the screen device 200, and may not be communicatively connected with the electronic device 100.

The terminal device 300 may display a guide UI 4105 for adjusting the curvature of the screen device 200 on the display of the terminal device 300. Here, the terminal device 300 may obtain a user input for adjusting the curvature of the screen device 200 through the guide UI 4105.

Here, the guide UI 4105 may include an area 4110 indicating text information guiding that the curvature of the screen device 200 is controlled, and an area 4120 for receiving a user input. Here, the terminal device 300 may receive a user input 4130 related to the curvature of the screen device 200 through the area 4120.

The screen device 200 may adjust the curvature of the screen device 200 based on a curvature value corresponding to the user input 4130.

According to one or more embodiments, the terminal device 300 may transmit a user input that is input into the terminal device 300 to the electronic device 100. Then, the electronic device 100 may obtain a curvature value corresponding to the user input. Then, the electronic device 100 may transmit the obtained curvature value to the screen device 200. Then, the screen device 200 may adjust the curvature based on the received curvature value.

According to one or more embodiments, the terminal device 300 may obtain a curvature value based on a user input. Then, the terminal device 300 may transmit the obtained curvature value to the electronic device 100. The electronic device 100 may then transmit the received curvature value to the screen device 200. Then, the screen device 200 may adjust the curvature based on the received curvature value.

According to one or more embodiments, the terminal device 300 may transmit a user input that is input into the terminal device 300 to the screen device 200. The screen device 200 may obtain a curvature value based on the received user input. Then, the screen device 200 may adjust the curvature based on the obtained curvature value.

According to one or more embodiments, the terminal device 300 may obtain a curvature value based on a user input. Then, the terminal device 300 may transmit the obtained curvature value to the screen device 200. Then, the screen device 200 may adjust the curvature based on the received curvature value.

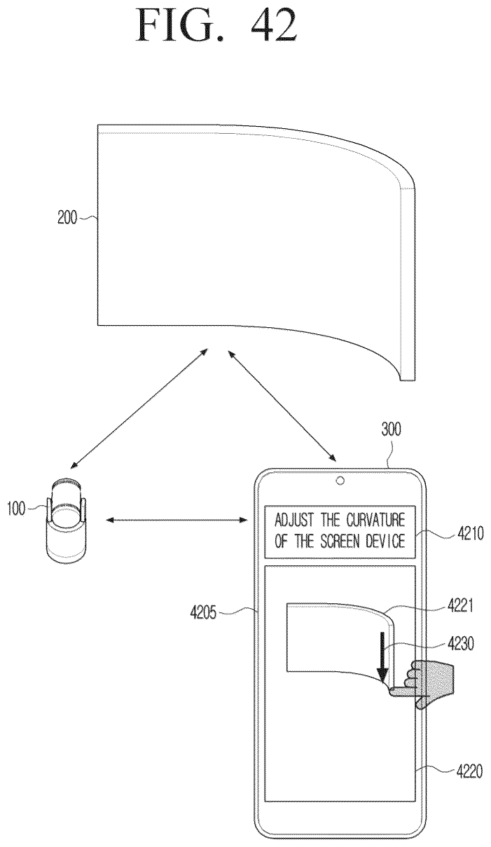

FIG. 42 is a diagram for illustrating an operation of adjusting a curvature of the screen device 200 through the terminal device 300 according to one or more embodiments.

Referring to FIG. 42, the terminal device 300 may display a guide UI 4205 for adjusting the curvature of the screen device 200 on the display of the terminal device 300. Here, the terminal device 300 may obtain a user input for adjusting the curvature of the screen device 200 through the guide UI 4205.

Here, the guide UI 4205 may include an area 4210 indicating text information guiding that the curvature of the screen device 200 is controlled, and an area 4220 for receiving a user input. Also, the terminal device 300 may display an image 4221 corresponding to the bent screen device 200 in the area 4220 based on the current curvature. If the curvature of the screen device 200 is 0, an image corresponding to the screen device 200 in a form of a plane that is not bent may be displayed. Here, the terminal device 300 may receive a user input 4230 related to the curvature of the screen device 200 through the area 4220.

The screen device 200 may adjust the curvature of the screen device 200 based on a curvature value corresponding to the user input 4230. For example, if the user input the user input 4230 that makes an image corresponding to the right portion of the screen device 200 bent, the screen device 200 may perform control such that the right portion of the screen device 200 is bent based on the user input 4230.

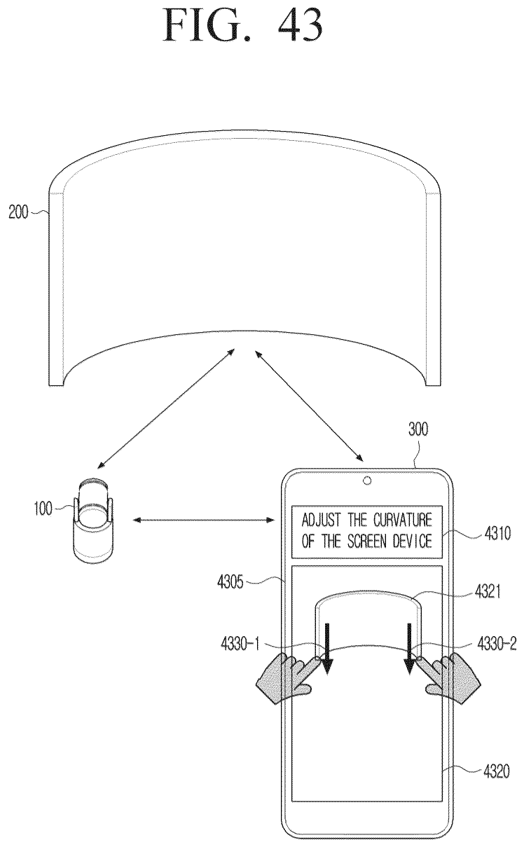

FIG. 43 is a diagram for illustrating an operation of adjusting a curvature of the screen device 200 through the terminal device 300 according to one or more embodiments.

Referring to FIG. 43, the terminal device 300 may display a guide UI 4305 for adjusting the curvature of the screen device 200 on the display of the terminal device 300. Here, the terminal device 300 may obtain a user input for adjusting the curvature of the screen device 200 through the guide UI 4305.

Here, the guide UI 4305 may include an area 4310 indicating text information guiding that the curvature of the screen device 200 is controlled, and an area 4320 for receiving a user input. Also, the terminal device 300 may display an image 4321 corresponding to the bent screen device 200 in the area 4320 based on the current curvature. If the curvature of the screen device 200 is 0, an image corresponding to the screen device 200 in a form of a plane that is not bent may be displayed. Here, the terminal device 300 may receive a user input 4330-1, 4330-2 related to the curvature of the screen device 200 through the area 4320.

The screen device 200 may adjust the curvature of the screen device 200 based on a curvature value corresponding to the user input 4330-1, 4330-2. For example, if the user input the user input 4330-1, 4330-2 that makes images corresponding to the left portion and the right portion of the screen device 200 bent, the screen device 200 may perform control such that the left portion and the right portion of the screen device 200 are bent based on the user input 4330-1, 4330-2.

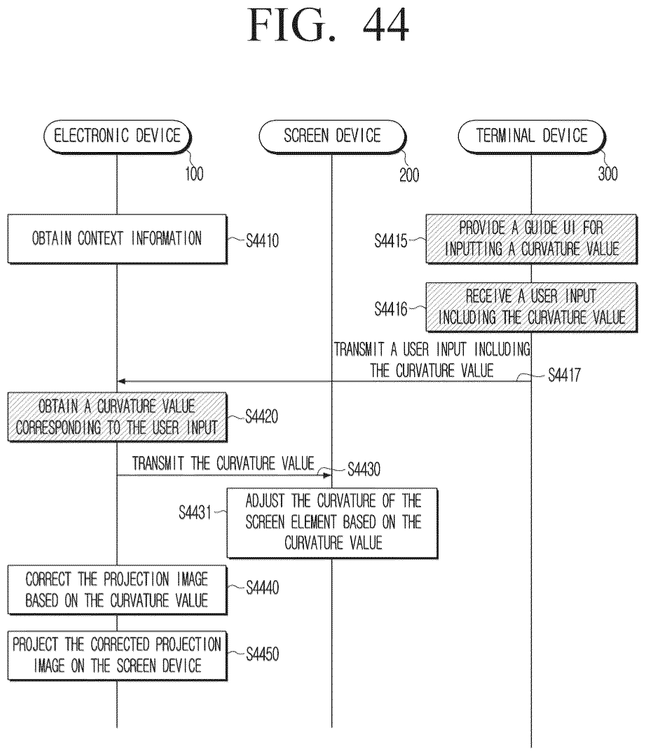

FIG. 44 is a flow chart for illustrating an operation of adjusting a curvature of the screen device 200 through the terminal device 300 according to one or more embodiments.

Referring to FIG. 44, the operations S4410, S4430, S4431, S4440, and S4450 may correspond to the operations S1610, S1630, S1631, S1640, and S1650 in FIG. 16. Accordingly, overlapping explanation will be omitted.

The terminal device 300 may provide a guide UI for inputting a curvature value based on a predetermined event (e.g., a user command) in operation S4415. The terminal device 300 may receive a user input including a curvature value in operation S4416. The terminal device 300 may transmit the user input including the curvature value to the electronic device 100 in operation S4417. Here, the user input including the curvature value may also be described as a user input indicating a curvature value.

The electronic device 100 may receive the user input including the curvature value from the terminal device 300. The electronic device 100 may obtain the curvature value corresponding to the user input in operation S4420.

Afterwards, the electronic device 100 may perform the operations S4430 to S4450.

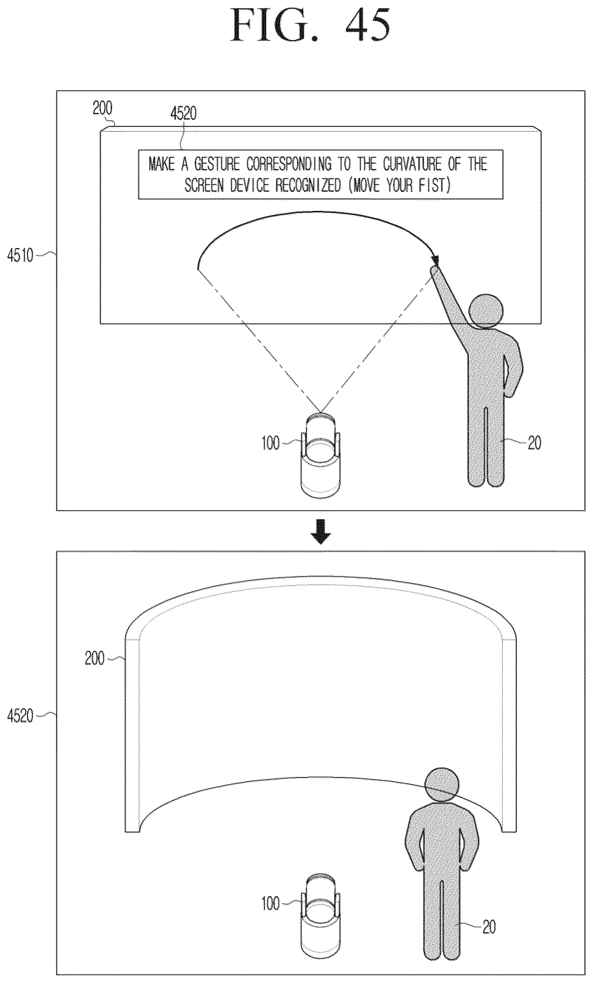

FIG. 45 is a diagram for illustrating an operation of adjusting a curvature of the screen device 200 based on a user gesture.

Referring to FIG. 45, the electronic device 100 may obtain a curvature value based on a user gesture.

Referring to the embodiment 4510 in FIG. 45, the screen device 200 may exist in a state of a plane. Here, the electronic device 100 may obtain a captured image including the user 20 through the sensor part 121 based on a predetermined event. Here, the predetermined event may include a user command for controlling the curvature of the screen device 200 or a command for initiating content projection, etc. Here, the captured image may also be described as sensing data.

Here, the electronic device 100 may project a guide UI 4520 for guiding a user gesture.

Here, the sensor part 121 may include an image sensor or a camera. Accordingly, the electronic device 100 may obtain a gesture of the user 20 based on consecutive captured images that were obtained through the sensor part 121. Then, the electronic device 100 may obtain a curvature value of the screen device 200 based on the gesture of the user 20. Here, the gesture of the user 20 may mean moving of a predetermined gesture.

For example, a moving route of a fist while the user 20 is clenching a fist may be recognized as one gesture. Then, the electronic device 100 may determine the curvature value of the screen device 200 such that the moving route of the predetermined gesture becomes the curvature of the screen device 200.

Referring to the embodiment 4520 in FIG. 45, after a user gesture is recognized, the electronic device 100 may obtain a curvature value based on the user gesture. The electronic device 100 may transmit the curvature value to the screen device 200, and the screen device 200 may adjust the curvature based on the curvature value.

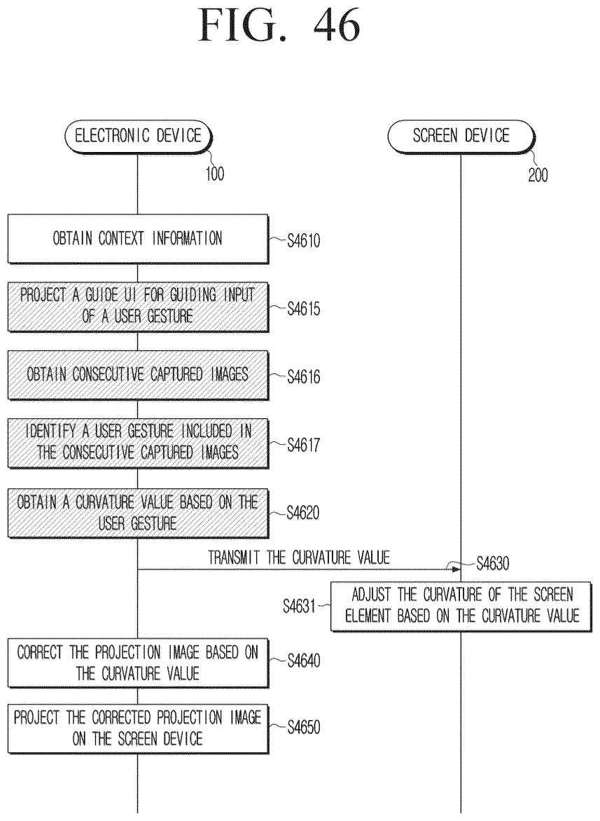

FIG. 46 is a flow chart for illustrating an operation of adjusting a curvature of the screen device 200 based on a user gesture.

The operations S4610, S4630, S4631, S4640, and S4650 in FIG. 46 may correspond to the operations S1610, S1630, S1631, S1640, and S1650 in FIG. 16. Accordingly, overlapping explanation will be omitted.

After obtaining context information, the electronic device 100 may project a guide UI for guiding input of a user gesture in operation S4615. Here, the guide UI may include at least one of text information requesting to make a user gesture recognized or text information indicating a command for a user to take a specific gesture and move.

Also, the electronic device 100 may obtain consecutive captured images including the user 20 in operation S4616. The electronic device 100 may identify a user gesture included in the consecutive captured images in operation S4617. The electronic device 100 may obtain a moving route of the user gesture.

Also, the electronic device 100 may obtain a curvature value based on the user gesture in operation S4620. The electronic device 100 may determine the moving route of the user gesture as the curvature of the screen device 200.

Afterwards, the electronic device 100 may perform the operations S4630 to S4650.

FIG. 47 is a diagram for illustrating an operation of adjusting a curvature of the screen device 200 based on information on the number of users.

Referring to the embodiment 4710 in FIG. 47, the electronic device 100 may identify the number of users, and the number of users is one. If the number of users is one, the electronic device 100 may identify a curvature value of the screen device 200 based on the position of the one user 20-1.

Referring to the embodiment 4720 in FIG. 47, the electronic device 100 may identify the number of users as a plurality of users. It is assumed that the number of users is two. If the number of users exceeds one, the electronic device 100 may determine the curvature value of the screen device 200 in consideration of both of the positions of the users 20-1, 20-2.

According to one or more embodiments, if the users exceed one, the electronic device 100 may adjust the curvature of the screen device 200 based on an average value of the positions of the users 20-1, 20-2. In other words, the curvature value is set based on the first position information of the screen, the second position information of a first user 20-1, and a third position information of a second user 20-2.

According to one or more embodiments, if the users exceed one, the electronic device 100 may determine the curvature of the screen device 200 as 0.

FIG. 48 is a flow chart for illustrating an operation of adjusting a curvature of the screen device 200 based on information on the number of users.

The operations S4811, S4812, S4820, S4830, S4831, S4840, and S4850 in FIG. 48 may correspond to the operations S2311, S2312, S2320, S2330, S2331, S2340, and S2350 in FIG. 23. Accordingly, overlapping explanation will be omitted.

After obtaining the first position information and the second position information, the electronic device 100 may obtain information on the number of users in operation S4813. The electronic device 100 may obtain context information including the first position information, the second position information, and the information on the number of users.

If the number of users exceeds one, the electronic device 100 may determine the curvature value of the screen device 200 in consideration of the positions of the plurality of users.

Afterwards, the electronic device 100 may perform the operations S4820 to S4850.

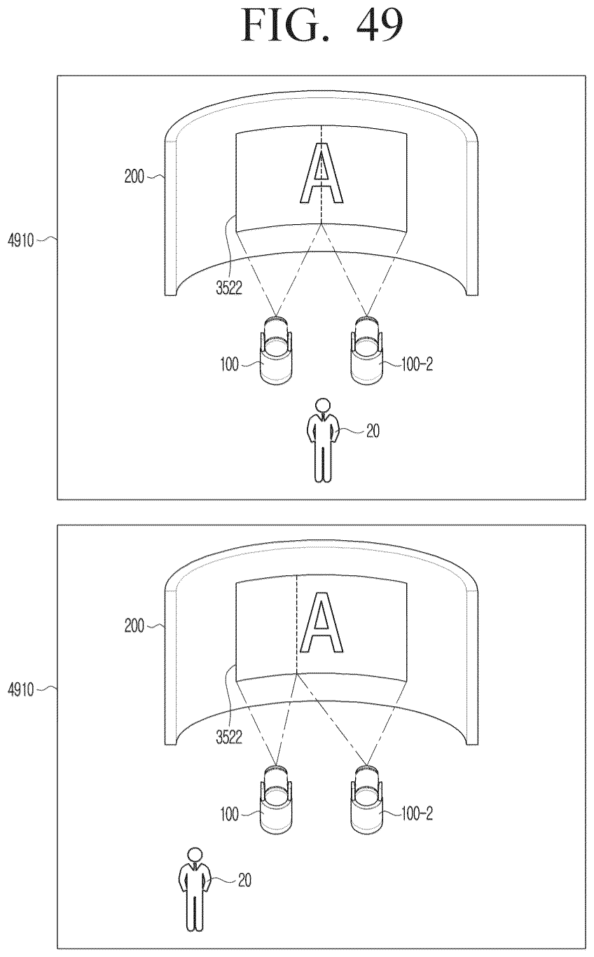

FIG. 49 is a diagram for illustrating an operation of projecting a projection image by a plurality of devices.

Referring to the embodiment 4910 in FIG. 49, both of the electronic device 100 and the external device 100-2 may project projection images. One projection image may be divided, and the first image portion may be projected by the electronic device 100, and the remaining second image portion may be projected by the external device 100-2. Here, it is assumed that the user 20 is located in front of the screen device 200. The electronic device 100 may obtain a curvature value of the screen device 200 in consideration of the position of the user 20. The curvature of the screen device 200 may be adjusted based on the obtained curvature value.

Here, the electronic device 100 may divide a projection image in consideration of the position information of the external device 200-1. The electronic device 100 may divide a first image portion to be output from the electronic device 100 and a second image portion to be output from the external device 100-2 in the projection image.

Referring to the embodiment 4920 in FIG. 49, it is assumed that the user 20 is located on the left side based on the direction in which the electronic device 100 faces the screen device 200. The curvature value of the screen device 200 may vary according to the position of the user 20. Here, the divided fist image portion and second image portion may vary based on the curvature value. As the curvature value varies according to the position of the user 20, the first image portion and the second image portion may also vary ultimately according to the position of the user 20.

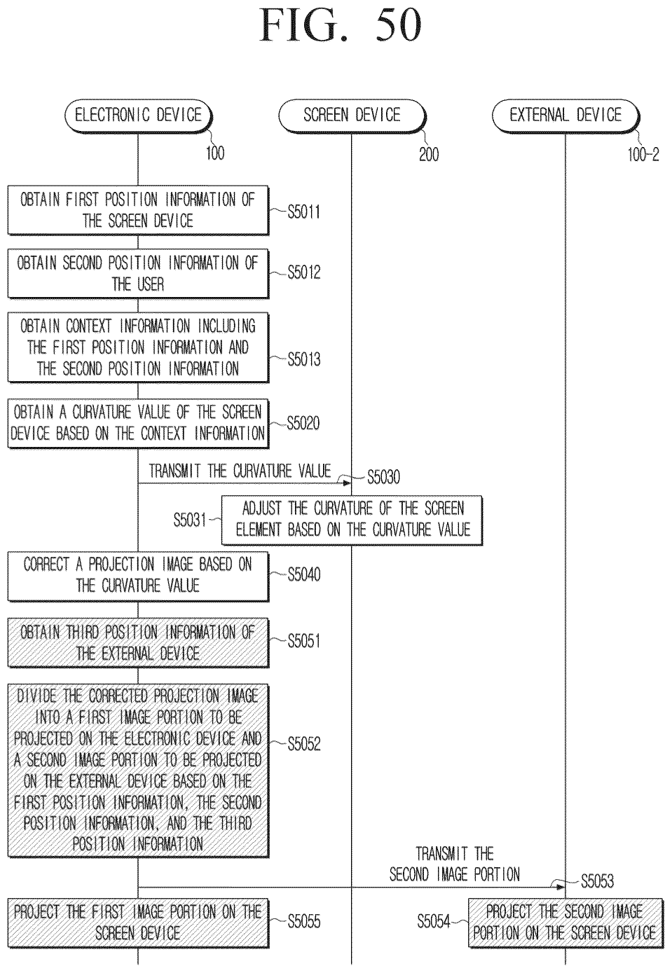

FIG. 50 is a flow chart for illustrating an operation of projecting a projection image by a plurality of devices.

Referring to FIG. 50, the operations S5011, S5012, S5013, S5020, S5030, S5031, S5040 may correspond to the operations S2311, S2312, S2320, S2330, S2331, S2340, and S2350 in FIG. 23. Accordingly, overlapping explanation will be omitted.

After a projection image is corrected, the electronic device 100 may obtain the third position information of the external device 200-1 in operation S5051. Also, the electronic device 100 may divide the corrected projection image into the first image portion and the second image portion based on the first position information, the second position information, and the third position information in operation S5052. Here, the first image portion may be a portion projected by the electronic device 100. Here, the second image portion may be a portion projected by the external device 200-1.

The electronic device 100 may transmit the second image portion to the external device 200-1 in operation S5053.

The external device 200-1 may receive the second image portion from the electronic device 100. Then, the screen device 200 may project the second image portion on the screen device 200 in operation S5054.

The electronic device 100 may project the first image portion on the screen device 200 in operation S5055.

FIG. 51 is a diagram for illustrating an operation of adjusting a curvature of the screen device 200 according to one or more embodiments.

Referring to FIG. 51, the screen device 200 may include at least one of a screen element 201, a support element 202, a guide element 203-1, 203-2, a motor 204-1, 204-2, or a fixing element 205-1, 205-2.

The screen device 200 may control at least one of the screen element 201, the support element 202, the guide element 203-1, 203-2, the motor 204-1, 204-2, or the fixing element 205-1, 205-2 based on a curvature value.

Here, the screen element 201 may mean an area wherein a projection image is projected. Also, here, the screen element 201 may mean a projection surface.

Here, the support element 202 may be an element that supports physical force transmitted from the guide element 203-1, 203-2 such that the screen element 201 is bent.

Here, the guide element 203-1, 203-2 may be an element that transmits physical force transmitted from the motor 204-1, 204-2 to the support element 202. Here, the guide element 203-1, 203-2 may be moved according to a user command.

Here, the motor 204-1, 204-2 may generate physical force.

Here, the fixing element 205-1, 205-2 may be an element that fixes a portion of the guide element 203-1, 203-2. For example, the fixing element 205-1, 205-2 may be wound around a portion of the guide element 203-1, 203-2.

Referring to the embodiment 5110 in FIG. 51, the screen device 200 may be in a state of a plane. Here, the screen device 200 may control the motor 204-1, 204-2 such that minimal physical force is transmitted to the screen element 201 or the support element 202 by adjusting the guide element 203-1, 203-2 to a minimum length. Here, the fixing element 205-1, 205-2 may be wound around as many portions as possible of the guide element 203-1, 203-2.

Referring to the embodiment 5120 in FIG. 51, only the left portion of the screen device 200 may be bent based on the direction in which the electronic device 100 faces the screen device 200. The screen device 200 may control the motor 204-1 such that the guide element 203-1 transmits force to the left portion of the screen element 201 or the left portion of the support element 202. Also, the left portion of the screen element 201 may be bent based on the curvature value. Meanwhile, the screen device 200 may maintain the right portion of the screen element 201 as a plane by controlling the motor 204-2 in the same manner as in the embodiment 5110.

Referring to the embodiment 5220 in FIG. 51, all of the portions on both sides of the screen device 200 may be bent based on the direction in which the electronic device 100 faces the screen device 200. The screen device 200 may control the motor 204-1 such that the guide element 203-1 transmits force to the left portion of the screen element 201 or the left portion of the support element 202. Also, the left portion of the screen element 201 may be bent based on the curvature value. In addition, the screen device 200 may control the motor 204-2 such that the guide element 203-2 transmits force to the right portion of the screen element 201 or the right portion of the support element 202. Further, the right portion of the screen element 201 may be bent based on the curvature value.

Meanwhile, according to one or more embodiments, the screen device 200 wherein the support element 202 does not exist may be implemented.

Meanwhile, according to one or more embodiments, the arranged positions of the motor 204-1, 204-2 and the arranged positions of the fixing element 205-1, 205-2 may be changed with one another. For example, the fixing element 205-1, 205-2 may be arranged to be closer to the screen element 201 than the motor 204-1, 204-2, and the motor 204-1, 204-2 may be arranged to be farther from the screen element 201 than the fixing element 205-1, 205-2.

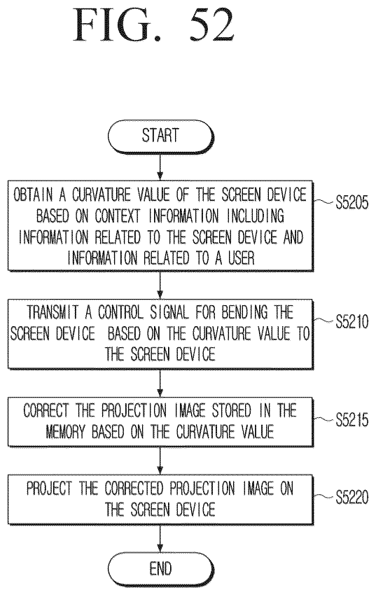

FIG. 52 is a flow chart for illustrating a controlling method of the electronic device 100 according to one or more embodiments.

Referring to FIG. 52, a method for controlling an electronic device 100 configured to project an image on a screen device 200 whose curvature is variable and store the projection image may include the steps of obtaining a curvature value of the screen device 200 based on context information including information related to the screen device 200 and information related to a user (S5205), transmitting a control signal for bending the screen device 200 based on the curvature value to the screen device 200 (S5210), correcting the stored projection image based on the curvature value (S5215), and projecting the corrected projection image on the screen device 200 (S5220).

Meanwhile, the controlling method may further include the steps of obtaining first position information of the screen device 200, obtaining second position information of the user based on sensing data obtained through a sensor part 121 of the electronic device 100, and obtaining the context information including the first position information and the second position information, and in the operation S5205 of obtaining the curvature value, the curvature value may be obtained based on the first position information and the second position information.

Meanwhile, in the operation of obtaining the first position information, a request signal for identifying the position of the screen device 200 may be transmitted to the screen device 200, and the first position information of the screen device 200 may be obtained based on a received response signal.

Meanwhile, in the operation of obtaining the context information, first distance information between the screen device 200 and the electronic device 100 may be obtained based on the first position information, second distance information between the user and the electronic device 100 may be obtained based on the second position information, and the context information including the first position information, the second position information, the first distance information, and the second distance information may be obtained.

Meanwhile, in the operation S5205 of obtaining the curvature value, information on a content type corresponding to the projection image may be obtained, the context information including the content type information may be obtained, and the curvature value may be obtained based on the content type information of the projection image.

Meanwhile, in the operation S5215 of correcting the projection image, the first position information of the screen device 200 may be obtained, and the projection image may be corrected based on the first position information and the curvature value.

Meanwhile, the projection image may include a plurality of pixels, and in the operation S5215 of correcting the projection image, projection positions wherein each of the plurality of pixels is projected on the screen device 200 may be obtained, and the projection image may be corrected based on distances between the electronic device 100 and the projection positions of each of the plurality of pixels.

Meanwhile, the controlling method may further include the step of, based on receiving a user input obtained based on a UI displayed on a terminal device from the terminal device, determining a curvature value included in the user input as the curvature value, and the user input may be a drag input.

Meanwhile, the screen device 200 may include a motor 204-1, 204-2, a support element 202 for supporting a screen element 201 of the screen device 200, and a guide element 203-1, 203-2 for bending the screen element 201 by contacting the support element 202, and in the operation S5210 of transmitting a control signal to the screen device 200, a control signal for controlling the motor 204-1, 204-2 such that the guide element 203-1, 203-2 contacts the support element 202 and the screen element 201 is bent based on the curvature value may be transmitted to the screen device 200.

Meanwhile, in the operation S5210 of transmitting a control signal to the screen device 200, a control signal for the guide element 203-1, 203-2 to contact at least one area from among a first portion of the support element 202 or a second portion of the support element 202 and bend the screen element 201 based on the curvature value may be transmitted to the screen device 200.

Meanwhile, the controlling method of an electronic device as in FIG. 52 may be executed on an electronic device having the configuration as in FIG. 2 or FIG. 3, and may also be executed on electronic devices having other configurations.

Meanwhile, methods according to the aforementioned one or more embodiments of the disclosure may be implemented in forms of applications that can be installed on conventional electronic devices.

Also, the methods according to the aforementioned one or more embodiments of the disclosure may be implemented just with software upgrade, or hardware upgrade of conventional electronic devices.

In addition, the aforementioned one or more embodiments of the disclosure may be performed through an embedded server provided on an electronic device, or an external server of at least one of an electronic device or a display device.

Meanwhile, according to an embodiment of the disclosure, the aforementioned one or more embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned one or more embodiments of the disclosure may be provided while being included in a computer program product. A computer program product refers to a product, and it can be traded between a seller and a buyer. A computer program product can be distributed on-line in the form of a storage medium that is readable by machines (e.g.: compact disc read only memory (CD-ROM)), or through an application store (e.g. Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned one or more embodiments (e.g.: a module or a program) may consist of a singular object or a plurality of objects, and among the aforementioned corresponding sub components, some sub components may be omitted, or other sub components may be further included in the one or more embodiments. Alternatively or additionally, some components (e.g.: a module or a program) may be integrated as an object, and perform functions that were performed by each of the components before integration identically or in a similar manner. Also, operations performed by a module, a program, or other components according to the one or more embodiments may be executed sequentially, in parallel, repetitively, or heuristically. Or, at least some of the operations may be executed in a different order or omitted, or other operations may be added.

Further, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device configured to project an image on a screen whose curvature is variable, the electronic device comprising:
a projector;
at least one processor; a communication interface configured to communicate with the screen; and
memory storing images and instructions that, when executed by the at least one processor, cause the at least one processor to:
obtain a curvature value of the screen based on context information related to the screen;
transmit a control signal through the communication interface to the screen for bending the screen based on the curvature value;
correct an image of the images stored in the memory based on the curvature value; and
control the projector to project the corrected image on the screen.

2. The electronic device of claim 1, further comprising:
a sensor,
wherein the instructions further cause the at least one processor to:
obtain first position information of the screen;
obtain second position information of a user based on sensing data obtained through the sensor; and
obtain the curvature value based on the first position information and the second position information,
wherein the context information comprises the first position information and the second position information.

3. The electronic device of claim 2, wherein the instructions further cause the at least one processor to:
transmit a request signal through the communication interface to the screen for identifying a position of the screen; and
obtain the first position information of the screen based on a response signal received through the communication interface.

4. The electronic device of claim 2, wherein the instructions further cause the at least one processor to:
obtain first distance information between the screen and the electronic device based on the first position information; and
obtain second distance information between the user and the electronic device based on the second position information,
wherein the context information comprises the first position information, the second position information, the first distance information, and the second distance information.

5. The electronic device of claim 1, wherein the instructions further cause the at least one processor to:
obtain a content type corresponding to the image; and
obtain the curvature value based on the content type of the image,
wherein the context information comprises the content type.

6. The electronic device of claim 1, wherein the instructions further cause the at least one processor to:
obtain the first position information of the screen; and
correct the image based on the first position information and the curvature value.

7. The electronic device of claim 6,
wherein the image comprises a plurality of pixels, and
the instructions further cause the at least one processor to:
obtain projection positions wherein the plurality of pixels are projected on the screen; and
correct the image based on distances between the electronic device and the projection positions of the plurality of pixels.

8. The electronic device of claim 1,
wherein the instructions further cause the at least one processor to:
based on receiving a user input through the communication interface from a terminal device, obtained based on a UI displayed on the terminal device, determine a curvature value of the user input as the curvature value, and
wherein the user input is a drag input.

9. The electronic device of claim 1,
wherein the screen comprises:
a motor;
a screen element;
a support that supports the screen element; and
a guide configured to bend the screen element by contacting the support, and
wherein the control signal is for controlling the motor such that the guide contacts the support and the screen element is bent based on the curvature value.

10. The electronic device of claim 9, wherein the control signal is for the guide to contact at least one area from among a first portion of the support or a second portion of the support and bend the screen element based on the curvature value.

11. A method for controlling an electronic device configured to project an image on a screen whose curvature is variable, the method comprising:
obtaining a curvature value of the screen based on context information related to the screen;
transmitting a control signal to the screen for bending the screen based on the curvature value;
correcting the image based on the curvature value; and
projecting the corrected image on the screen.

12. The controlling method of claim 11, further comprising:
obtaining first position information of the screen;
obtaining second position information of a user based on sensing data obtained through a sensor of the electronic device; and
obtaining the curvature value based on the first position information and the second position information,
wherein the context information comprises the first position information and the second position information.

13. The controlling method of claim 12, wherein the obtaining the first position information comprises:
transmitting a request signal to the screen for identifying a position of the screen; and
obtaining the first position information of the screen based on a received response signal.

14. The controlling method of claim 12, wherein the obtaining the context information comprises:
obtaining first distance information between the screen and the electronic device based on the first position information; and
obtaining second distance information between the user and the electronic device based on the second position information,
wherein the context information comprises the first position information, the second position information, the first distance information, and the second distance information.

15. The controlling method of claim 11, wherein the obtaining the curvature value comprises:
obtaining a content type corresponding to the image; and
obtaining the curvature value based on the content type of the image,
wherein the context information comprises the content type.

16. An electronic device configured to project an image on a screen whose curvature is variable, the electronic device comprising:
a projector;
at least one processor;
a communication interface configured to communicate with the screen; and
memory storing images and instructions that, when executed by the at least one processor, cause the at least one processor to:
obtain first position information of the screen;
obtain second position information of a first user;
obtain third position information of a second user;
obtain a curvature value of the screen based on the first position information, the second position information, and the third position information;
transmit a control signal through the communication interface to the screen for bending the screen based on the curvature value;
correct an image of the images stored in the memory based on the curvature value; and
control the projector to project the corrected image on the screen.
